(19) United States
(12) Patent Application Publication
(10) Pub. No.: US 2023/0109010 A1
(43) Pub. Date: Apr. 6, 2023

(54) PESTICIDE COMPOSITIONS WITH SUPRAMOLECULAR STRUCTURES FOR AGRICULTURAL USE

(71) Applicant: BPS JUST ENERGY TECHNOLOGY, LLC, Argyle, TX (US)

(72) Inventors: Robert A. GEIGER, Argyle, TX (US); David J. COORTS, Argyle, TX (US); Donna Jean SHOTWELL, Argyle, TX (US)

(21) Appl. No.: 17/800,457

(22) PCT Filed: Feb. 17, 2021
(86) PCT No.: PCT/US2021/018424

§ 371 Date: Aug. 17, 2022

Related U.S. Application Data
(60) Provisional application No. 62/978,255, filed on Feb. 18, 2020.

(51) Int. Cl. A01N 57/20; A01N 57/12; A01P 13/00; A01N 37/20; A01N 41/10; A01P 3/00; A01N 43/54; A01N 43/56; A01N 33/18; A01N 43/36; A01P 7/04; A01N 25/02

(52) U.S. Cl. CPC A01N 57/20; A01N 25/02; A01N 33/18; A01N 37/20; A01N 41/10; A01N 43/36; A01N 43/54; A01N 43/56; A01N 57/12; A01P 3/00; A01P 7/04; A01P 13/00

(57) ABSTRACT

Compositions with supramolecular structures for agricultural use include a pesticide, a supramolecular host chemical or a supramolecular guest chemical configured to engage in host-guest chemistry with the pesticide, and a solvent, and methods of preparing the same, are included. Methods of controlling weeds at a crop site include applying an agriculturally effective amount of the composition to the crop site are also included.

### BACKGROUND OF THE DISCLOSURE

There has been rising importance in the agricultural industry to use pesticides that have increased effectiveness or have less toxicological and environmental concerns. There has been an expansion of utilizing these products to improve crop performance by removing unwanted pests without adding negative health and environmental impacts.

The agriculture industry has been heavily focusing on finding new pesticide active ingredients to increase performance or to overcome pest resistance. Developing base level pesticide active chemistries, however, is extremely challenging due to the long discovery phase of finding a new molecule that has safe and effective pesticidal properties. To overcome these challenges, there has been focus on finding inert ingredients that have synergy with the active ingredient. Normally this is in the form of an adjuvant that enhances surface contact with the active on the leaf’s surface.

Although these techniques overcome some challenges, there has been a growing concern on active ingredient assimilation while using the minimal amount of active ingredients to minimize environmental pollution and increase long-term sustainability.

### SUMMARY OF THE DISCLOSURE

In one aspect, the disclosure encompasses a composition that includes a pesticide, a supramolecular host or guest chemical configured to engage in host-guest chemistry with the pesticide, and the solvent. In one embodiment, the solvent is a polar solvent, such as water or alcohol. In another embodiment, the solvent is a non-polar solvent such as oil or mineral oil. In various embodiments, the pesticide includes an acaricide, an avicide, a chemosterilant, an herbicide, an insecticide, a molluscicide, an algicide, a bactericide, a fungicide, a nematicide, a virucide, a rodenticide, or any combination thereof.

The disclosure also encompasses a method that includes preparing the composition that includes mixing components of the composition in the following order: (1) solvent and (2) the pesticide to form a mixture, and adding (3) the supramolecular host or guest chemical to mixture to form the composition. In certain situations, the order of addition may be reversed due to the composition, or a portion thereof, being mixed already or the manner in which it is combined, e.g., suspension or emulsion.

The disclosure further encompasses a method for controlling unwanted pests (i.e. weeds, insects, fungus, or rodents, or any combination thereof) at a crop site that includes applying a composition to the crop site in an agriculturally effective amount, wherein the composition includes a pesticide, a supramolecular host or guest chemical configured to engage in host-guest chemistry with the pesticide, and the solvent.

### BRIEF DESCRIPTION OF THE DRAWINGS

The present disclosure is best understood from the following detailed description when read with the accompanying figures.

FIG. 1 is a graph showing increased weed control for palmer amaranth weeds in corn after 28 days when acetochlor is used as the pesticide in Example 1;

FIG. 2 is a graph showing increased weed control for fall panicum weeds in corn after 28 days when acetochlor is used as the pesticide in Example 1;

FIG. 3 is a graph showing increased weed control for large crabgrass weeds in corn after 28 days when acetochlor is used as the pesticide in Example 1;

FIG. 4 is a graph showing increased weed control for palmer amaranth weeds in corn after 28 days when s-metolachlor is used as the pesticide in Example 1.

FIG. 5 is a graph showing increased weed control for fall panicum weeds in corn after 28 days when s-metolachlor is used as the pesticide in Example 1;

FIG. 6 is a graph showing increased weed control for large crabgrass weeds in corn after 28 days when s-metolachlor is used as the pesticide in Example 1;

FIG. 7 is a graph showing increased weed control for palmer amaranth weeds in corn after 14 days when glufosinate is used as the pesticide in Example 2;

FIG. 8 is a graph showing increased weed control for ivyleaf morning glory weeds in corn after day 14 when glufosinate is used as the pesticide in Example 2;

FIG. 9 is a graph showing increased weed control for fall panicum weeds in corn after 14 days when glufosinate is used as the pesticide in Example 2;

FIG. 10 is a graph showing increased weed control for large crabgrass weeds in corn after 14 days when glufosinate is used as the pesticide in Example 2;

FIG. 11 is a graph showing increased weed control for palmer amaranth weeds in corn after 14 days when glyphosate is used as the pesticide in Example 2;

FIG. 12 is a graph showing increased weed control for ivyleaf morning glory weeds in corn after 14 days when glyphosate is used as the pesticide in Example 2;

FIG. 13 is a graph showing increased weed control for fall panicum weeds in corn after 14 days when glyphosate is used as the pesticide in Example 2;

FIG. 14 is a graph showing increased weed control for large crabgrass weeds in corn after 14 days when glyphosate is used as the pesticide in Example 2;

FIG. 15 is a graph showing increased weed control for palmer amaranth weeds in corn after 14 days when mesotrione is used as the pesticide in Example 2;

FIG. 16 is a graph showing increased weed control for ivyleaf morning glory weeds in corn after 14 days when mesotrione is the active ingredient for Example 2;

FIG. 17 is a graph showing increased weed control for fall panicum weeds in corn after 14 days when mesotrione is used as the pesticide in Example 2;

FIG. 18 is a graph showing increased weed control for large crabgrass weeds in corn after 14 days when mesotrione is used as the pesticide in Example 2;

FIG. 19 is a graph showing the fungal ring diameter for Botrytis cinerea when treated with azoxystrobin in Example 3;

FIG. 20 is a graph showing the fungal ring diameter for Macrophomina phaseoli when treated with azoxystrobin in Example 3;

FIG. 21 is a graph showing the fungal ring diameter for Fusarium graminearum when treated with azoxystrobin in Example 3;

FIG. 22 is a graph showing the fungal ring diameter for Sclerotinia sclerotiorum when treated with azoxystrobin in Example 3;

FIG. 23 is a graph showing the fungal ring diameter for Pythium irregular when treated with azoxystrobin in Example 3;

FIG. 24 graph showing the fungal ring diameter for Rhizoctonia solani when treated with azoxystrobin in Example 3;

FIG. 25 show the rate response for Macrophomina phaseoli when treated with azoxystrobin in Example 3;

FIG. 26 show the rate response for Sclerotinia sclerotiorum when treated with azoxystrobin in Example 3;

FIG. 27 show the rate response for Rhizoctonia solani when treated with azoxystrobin in Example 3;

FIG. 28 show the rate response for Pythium irregular when treated with azoxystrobin in Example 3;

FIG. 29 is a graph showing the fungal ring diameter for Botrytis cinerea when treated with tetraconzole in Example 3;

FIG. 30 is a graph showing the fungal ring diameter for Macrophomina phaseoli when treated with tetraconazole in Example 3;

FIG. 31 is a graph showing the fungal ring diameter for Fusarium graminearum when treated with tetraconazole in Example 3;

FIG. 32 is a graph showing the fungal ring diameter for Sclerotinia sclerotiorum when treated with tetraconazole in Example 3;

FIG. 33 is a graph showing the fungal ring diameter for Pythium irregular when treated with tetraconazole in Example 3;

FIG. 34 is a graph showing the fungal ring diameter for Rhizoctonia solani when treated with tetraconazole in Example 3;

FIG. 35 shows the rate response for Botrytis cinerea when treated with tetraconazole in Example 3;

FIG. 36 shows the rate response for Fusarium graminearum when treated with tetraconazole in Example 3;

FIG. 37 is a graph showing the fungal ring diameter for Botrytis cinerea when treated with fluxapyroxad in Example 3;

FIG. 38 is a graph showing the fungal ring diameter for Fusarium graminearum when treated with fluxapyroxad in Example 3;

FIG. 39 is a graph showing the fungal ring diameter for Macrophomina phaseoli when treated with fluxapyroxad in Example 3;

FIG. 40 is a graph showing the fungal ring diameter for Sclerotinia sclerotiorum when treated with fluxapyroxad in Example 3;

FIG. 41 is a graph showing the fungal ring diameter for Pythium irregular when treated with fluxapyroxad in Example 3;

FIG. 42 is a graph showing the fungal ring diameter for Rhizoctonia solani when treated with fluxapyroxad in Example 3;

FIG. 43 shows the rate response for Macrophomina phaseoli when treated with fluxapyroxad in Example 3;

FIG. 44 shows the rate response for Sclerotinia sclerotiorum when treated with fluxapyroxad in Example 3;

FIG. 45 shows the weed control for Prickly sida when treated with acetochlor in Example 4;

FIG. 46 shows the weed control for Hemp sesbania when treated with acetochlor in Example 4;

FIG. 47 shows the weed control for Hemp sesbania when treated with S-metolachlor in Example 4;

FIG. 48 shows the weed control for Prickly sida when treated with S-metolachlor in Example 4;

FIG. 49 is a graph showing the weed control for Hemp sesbania and Prickly sida when treated with trifluralin in Example 4;

FIG. 50 shows the rate response for Hemp sesbania when treated with mesotrione in Example 5;

FIG. 51 shows the rate response for Prickly sida when treated with mesotrione in Example 5;

FIG. 52 shows the rate response for Hemp sesbania when treated with saflufenacil in Example 5;

FIG. 53 shows the rate response for Prickly sida when treated with saflufenacil in Example 5;

FIG. 54 are microscopic images of pyraclostrobin supramolecular structures in Example 6;

FIG. 55 are microscopic images of the dry crystals of the fludioxonil control and fludioxonil supramolecular composition in Example 6;

FIG. 56 are microscopic images of the dry crystals of the pyrimethanil control and fludioxonil supramolecular composition in Example 6;

FIG. 57 are microscopic images of the dry crystals of the s-metolachlor control and s-metolachlor supramolecular composition in Example 6;

FIG. 58 are microscopic images of the dry crystals of the malathion control and malathion supramolecular composition in Example 6;

FIG. 59 are microscopic images of the dry crystals of the chlorantraniliprole control and chlorantraniliprole supramolecular composition in Example 6;

FIG. 60 are microscopic images of the dry crystals of the glyphosate control and glyphosate supramolecular composition in Example 6;

FIG. 61 are microscopic images of the dry crystals of the glufosinate control and glufosinate supramolecular composition in Example 6;

FIG. 62 is a graph showing the percent insects killed after 24 hours of treatment with chlorantraniliprole in Example 7; and

FIG. 63 is a graph showing the percent insects killed after 48 hours of treatment with chlorantraniliprole in Example 7.

### DETAILED DESCRIPTION

The present disclosure provides compositions and methods that address the need for a pesticide composition capable of increasing active ingredient assimilation and overall increase in performance without adding negative health and environmental impact, and that can be applied via typical industry practices. In particular, this disclosure describes pesticides that form supramolecular structures when mixed with a supramolecular host or guest chemical configured to engage in host-guest chemistry with the pesticide. The resulting compositions increase the pesticide’s efficiency, e.g., the compositions exhibit increased weed control, including weed prevention and reduced weed growth.

The compositions have an enhanced synergy that allows increased active ingredient assimilation and an overall increase in performance without adding negative health and environmental worries. Application of the compositions to plants increases the effective rate of the pesticide, is crop-safe without phytotoxicity, minimizes threats of pest resistance, and does not add any toxicological and environmental concerns. The compositions can be applied by soil drench, foliar, fertigation, seed treatment, or aerial methods.

The compositions include (1) a pesticide and (2) a supramolecular host or guest chemical configured to engage in host-guest chemistry with the pesticide. The formation of supramolecular structures in the compositions promotes an increased efficiency that is dependent on the pesticide group. For example, herbicide compositions will have increased herbicidal activity by killing more weeds more efficiently and more quickly. Such supramolecular structures or assemblies may take the form of, e.g., micelles, liposomes, nanostructures, or nanobubbles.

In various embodiments, the pesticide includes one or more of the following: (1) an acaricide, (2) an avicide, (3) a chemosterilant, (4) an herbicide, (5) an insecticide, (6) a molluscicide, (7) an algicide, (8) a bactericide, (9) a fungicide, (10) a nematicide, (11) a virucide, or (12) a rodenticide. For clarity, more than one component in a “category” may be included in the pesticide, along with combinations of pesticides from different categories above. Acaricides are pesticides used to kill ticks and mites, such as permethrin, cyfluthrin, bifenthrin, carbaryl, and pyrethrin. Avicides are any substance that is used to kill birds, such as strychnine, DRC-1339 (3-chloro-4-methylaniline hydrochloride), CPTH (3-chloro-p-toluidine), and 4-aminopyridine. Chemosterilants are chemical compounds that cause sterility in an organism, such as amethopterin and aminopterin. Herbicides are substances that are toxic to plants, used to destroyed unwanted vegetation, such as acetachlor, s-metolachlor, glufosinate, glyphosate, and mesotrione. Insecticides are substances used to kill insects, such as organochlorides, organophosphates, and carbamates. Molluscicides are pesticides that kill mollusks, such as copper sulfate and niclosamide. Algicides are substances that are poisonous to algae, such as bethoxazin and cybutryne. Bactericides are substances that kill bacteria, such as benzalkonium chloride and dichlone. Fungicides are chemicals that destroy fungus, such as thiocarbamates and organomercury compounds. Nematicides are substances used to kill nematode worms, such as carbofuran and oxymyl. Virucides are agents that deactivate or destroy viruses, such as detergents and chloroform. Rodenticides are poisons used to kill rodents, such as zinc phosphide, bromethalin, cholecalciferol, and strychnine.

The pesticide is present in any suitable amount, but is generally present in the composition in an amount of about 1 percent to about 99 percent by weight of the composition. In some embodiments, the pesticide is present in an amount of about 10 percent to about 95 percent, for example 20 percent to about 80 percent, by weight of the composition.

In selecting suitable supramolecular host or guest chemical, which can include one or more such host or guest chemicals, (1) the host chemical generally has more than one binding site, (2) the geometric structure and electronic properties of the host chemical and the guest chemical typically complement each other when at least one host chemical and at least one guest chemical is present, and (3) the host chemical and the guest chemical generally have a high structural organization, i.e., a repeatable pattern often caused by host and guest compounds aligning and having repeating units or structures. In some embodiments, the supramolecular host chemical or supramolecular guest chemical is provided in a mixture with water. Host chemicals may include nanostructures of various elements and compounds, or combinations of the foregoing, which may have a charge, may have magnetic properties, or both. Suitable supramolecular host chemicals include cavitands, cryptands, rotaxanes, catenanes, nanostructures, or any combination thereof.

Cavitands are container-shaped molecules that are capable of engaging in host-guest chemistry with guest molecules of a complementary shape and size. Examples of cavitands include cyclodextrins, calixarenes, pillarrenes, and cucurbiturils. Calixarenes are cyclic oligomers obtained by condensation reactions between para-t-butyl phenol and formaldehyde.

Cryptands are molecular entities including a cyclic or polycyclic assembly of binding sites that contain three or more binding sites held together by covalent bonds, and that define a molecular cavity in such a way as to bind guest ions. An example of a cryptand is N[CH₂CH₂OCH₂CH₂OCH₂CH2]₃N or 1,10-diaza-4,7,13,16,21,24-hexaoxabicyclo[8.8.8]hexacosane. Cryptands form complexes with many cations, including NH₄⁺, lanthanoids, alkali metals, and alkaline earth metals.

Rotaxanes are supramolecular structures in which a cyclic molecule is threaded onto an “axle” molecule and end-capped by bulky groups at the terminal of the “axle” molecule. Another way to describe rotaxanes are molecules in which a ring encloses another rod-like molecule having end-groups too large to pass through the ring opening. The rod-like molecule is held in position without covalent bonding.

Catenanes are species in which two ring molecules are interlocked with each other, i.e., each ring passes through the center of the other ring. The two cyclic compounds are not covalently linked to one another, but cannot be separated unless covalent bond breakage occurs.

Suitable supramolecular guest chemicals include cyanuric acid, water, and melamine, and are preferably selected from cyanuric acid or melamine, or a combination thereof. Another category of guest chemicals includes nanostructures of various elements and compounds, which may have a charge, may have magnetic properties, or both.

The supramolecular host chemical or the supramolecular guest chemical is present in the composition in any suitable amount, but is generally present in the composition in an amount of about 0.1 percent to about 99 percent by weight of the composition. In certain embodiments, the supramolecular host chemical or supramolecular guest chemical, or host and guest chemical combination, is present in an amount of about 2 percent to about 60 percent by weight of the composition, preferably in an amount of about 5 percent to about 40 percent by weight of the composition, while in other embodiments the supramolecular host or guest chemical is present in an amount of about 30 percent to about 98 percent by weight of the composition, for example, 50 percent to about 95 percent by weight of the composition, or preferably about 60 percent to about 90 percent by weight of the composition. In some embodiments, the supramolecular host chemical or supramolecular guest chemical is mixed with a pesticide at 50% w/w solution.

Any suitable solvent may be used, as long as the solvent is compatible with the pesticide. In one embodiment, a polar solvent, including for example water or any alcohol, may be used. Water is used as a preferred solvent for the different components of the composition. Water (or other polar solvent) is present in any suitable amount, but is generally present in the composition in an amount of about 10 percent to about 95 percent by weight of the composition. In certain embodiments, water is present in an amount of about 10 percent to about 75 percent by weight of the composition, for example, 20 percent to about 60 percent by weight of the composition. In one embodiment, a non-polar solvent, including for example mineral oil or any oil, may be used. Mineral oil may be used as a preferred solvent for the different components of the composition. Mineral oil (or other non-polar solvent) can be used in any suitable amount, but is generally present in the composition in an amount of about 10 percent to about 95 percent by weight of the composition. In certain embodiments, mineral oil is present in an amount of about 10 percent to about 75 percent by weight of the composition, for example, 20 percent to about 60 percent by weight of the composition.

The order of addition of the components of the composition can be important to obtain stable supramolecular structures or assemblies in the final mixture. The order of addition is typically: (1) solvent and (2) pesticide. Once these two components are fully mixed, the supramolecular host or guest chemical is added to the mixture and allowed to mix thoroughly with the other initial components.

The compositions described above are typically applied in an agriculturally effective amount to each plant. These compositions are preferably formed as a concentrate, which is “reconstituted” or otherwise diluted before application to the relevant vegetation (e.g., crops, plants, trees, etc.). The dilution typically occurs on or adjacent the site of application to minimize the need to transport large volumes of the product. The amount or concentration of the present compositions can vary depending on conditions (e.g., soil, humidity, pH, temperature, growing season, amount of daily light, etc.), the concentration and type of components as described herein, as well as the type of plant to which each composition is applied. In some embodiments, an “agriculturally effective amount” means from about 0.1 mL to 50 mL per gallon can be applied to saturate per pot of plant, or from about 20 mL to 100 mL of the solution made, and if the product is to be applied over a field then from about 0.1 qt to 4 qt concentrate of the product with about 5 to 100 gallons of water per acre.

The following examples are illustrative of the compositions and methods discussed above and are not intended to be limiting.

### EXAMPLES

### Example 1: Effect of Compositions on Palmer Amaranth, Fall Panicum, and Large Crabgrass

The herbicides tested were acetochlor and s-metolachlor. Each herbicide was combined at the specified rate with either deionized water or SymMAX™ supramolecular host chemistry that is commercially available from Shotwell Hydrogenics at 15 gallons per acre (GPA). Specified rates for acetochlor were 0.5 parts per acre, 1 part per acre, and 2 parts per acre. Specified rates for s-metolachlor were 0.75 parts per acre, 1 part per acre, and 2 parts per acre.

This example was conducted as a 4 replicate, RCBD (randomized control block design) in Quitman, GA. An untreated control was used as a standard that provided no weed control and no phytotoxicity. All treatments were compared to the untreated control. Counted dead weeds and living weeds were used to determine % weed control. The untreated control was also used to determine % crop phytotoxicity for the crop. Typical indications of phytotoxicity include chlorosis, stunting, epinasty, and/or leaf burn.

The trial ran for 28 days with weekly data assessments taken on % crop phytotoxicity and % weed control of three key species: palmer amaranth (Amaranthus palmeri), fall panicum (Panicum dichotomiflorum) and large crabgrass (Digitaria sanguinalis). The test field was over seeded with weed seed obtained from the University of Georgia prior to corn planting. Treatments were applied 3 days after planting as a broadcast application at various rates ranging from about 0.5 parts per acre to about 2 parts per acre. Tables 1-4 show the % weed control when the weeds are treated with acetachlor. Tables 4-8 show the % weed control when the weeds are treated with s-metolachlor.

TABLE 1

% WEED CONTROL AT 7 DAYS WITH ACETOCHLOR

| TREATMENT | % WEED CONTROL FOR PALMER AMARANTH | % WEED CONTROL FOR FALL PANICUM | % WEED CONTROL FOR LARGE CRABGRASS |
|---|---|---|---|
| Untreated Control | 0 | 0 | 0 |
| 2 parts/acre in Deionized Water | 93.3 | 87.3 | 87.0 |
| 2 parts/acre in SymMAX™ | 97.3 | 90.8 | 95.3 |
| 1 part/acre in Deionized Water | 88.5 | 69.3 | 74.5 |
| 1 part/acre in SymMAX™ | 96.8 | 91.3 | 92.5 |
| 0.5 part/acre in Deionized Water | 87.0 | 65.5 | 69.5 |
| 0.5 part/acre in SymMAX™ | 92.5 | 70.5 | 80.3 |

TABLE 2

% WEED CONTROL AT 14 DAYS WITH ACETOCHLOR

| TREATMENT | % WEED CONTROL FOR PALMER AMARANTH | % WEED CONTROL FOR FALL PANICUM | % WEED CONTROL FOR LARGE CRABGRASS |
|---|---|---|---|
| Untreated Control | 0 | 0 | 0 |
| 2 parts/acre in Deionized Water | 97.7 | 78.0 | 74.5 |
| 2 parts/acre in SymMAX™ | 94.7 | 68.8 | 66.3 |
| 1 part/acre in Deionized Water | 87.0 | 53.0 | 49.0 |
| 1 part/acre in SymMAX™ | 96.7 | 59.0 | 54.3 |
| 0.5 part/acre in Deionized Water | 82.3 | 49.3 | 45.8 |
| 0.5 part/acre in SymMAX™ | 89.3 | 55.5 | 45.0 |

TABLE 3

% WEED CONTROL AT 21 DAYS WITH ACETOCHLOR

| TREATMENT | % WEED CONTROL FOR PALMER AMARANTH | % WEED CONTROL FOR FALL PANICUM | % WEED CONTROL FOR LARGE CRABGRASS |
|---|---|---|---|
| Untreated Control | 0 | 0 | 0 |
| 2 parts/acre in Deionized Water | 90.0 | 81.3 | 73.3 |
| 2 parts/acre in SymMAX™ | 99.0 | 70.2 | 75.7 |
| 1 part/acre in Deionized Water | 81.0 | 40.9 | 43.0 |
| 1 part/acre in SymMAX™ | 94.0 | 64.7 | 68.3 |
| 0.5 part/acre in Deionized Water | 61.7 | 37.6 | 45.3 |
| 0.5 part/acre in SymMAX™ | 70.3 | 51.6 | 37.7 |

TABLE 4

% WEED CONTROL AT 28 DAYS WITH ACETOCHLOR

| TREATMENT | % WEED CONTROL FOR PALMER AMARANTH | % WEED CONTROL FOR FALL PANICUM | % WEED CONTROL FOR LARGE CRABGRASS |
|---|---|---|---|
| Untreated Control | 0 | 0 | 0 |
| 2 parts/acre in Deionized Water | 99.7 | 88.0 | 92.1 |
| 2 parts/acre in SymMAX™ | 99.7 | 90.7 | 95.5 |
| 1 part/acre in Deionized Water | 67.4 | 57.3 | 48.0 |
| 1 part/acre in SymMAX™ | 99.5 | 85.3 | 89.9 |
| 0.5 part/acre in Deionized Water | 44.5 | 60.0 | 47.8 |
| 0.5 part/acre in SymMAX™ | 73.2 | 57.0 | 68.3 |

TABLE 5

% WEED CONTROL AT 7 DAYS WITH S-METOLACHLOR

| TREATMENT | % WEED CONTROL FOR PALMER AMARANTH | % WEED CONTROL FOR FALL PANICUM | % WEED CONTROL FOR LARGE CRABGRASS |
|---|---|---|---|
| Untreated Control | 0 | 0 | 0 |
| 1.5 parts/acre in Deionized Water | 100.0 | 100.0 | 100.0 |
| 1.5 parts/acre in SymMAX™ | 100.0 | 100.0 | 100.0 |
| 1 part/acre in Deionized Water | 99.3 | 97.5 | 99.0 |
| 1 part/acre in SymMAX™ | 100.0 | 100.0 | 100.0 |
| 0.75 part/acre in Deionized Water | 96.0 | 91.3 | 92.0 |
| 0.75 part/acre in SymMAX™ | 100.0 | 97.5 | 98.8 |

TABLE 6

% WEED CONTROL AT 14 DAYS WITH S-METOLACHLOR

| TREATMENT | % WEED CONTROL FOR PALMER AMARANTH | % WEED CONTROL FOR FALL PANICUM | % WEED CONTROL FOR LARGE CRABGRASS |
|---|---|---|---|
| Untreated Control | 0 | 0 | 0 |
| 1.5 parts/acre in Deionized Water | 100.0 | 97.8 | 98.0 |
| 1.5 parts/acre in SymMAX™ | 100.0 | 98.0 | 96.0 |
| 1 part/acre in Deionized Water | 98.0 | 91.8 | 89.0 |
| 1 part/acre in SymMAX™ | 96.7 | 88.0 | 83.8 |
| 0.75 part/acre in Deionized Water | 94.3 | 83.5 | 82.8 |
| 0.75 part/acre in SymMAX™ | 100.0 | 94.0 | 92.5 |

TABLE 7

% WEED CONTROL AT 21 DAYS WITH S-METOLACHLOR

| TREATMENT | % WEED CONTROL FOR PALMER AMARANTH | % WEED CONTROL FOR FALL PANICUM | % WEED CONTROL FOR LARGE CRABGRASS |
|---|---|---|---|
| Untreated Control | 0 | 0 | 0 |
| 1.5 parts/acre in Deionized Water | 100.0 | 98.9 | 93.0 |
| 1.5 parts/acre in SymMAX™ | 100.0 | 98.4 | 98.0 |
| 1 part/acre in Deionized Water | 99.0 | 89.4 | 84.3 |
| 1 part/acre in SymMAX™ | 100.0 | 89.6 | 90.7 |
| 0.75 part/acre in Deionized Water | 96.0 | 90.1 | 91.3 |
| 0.75 part/acre in SymMAX™ | 100.0 | 97.9 | 95.3 |

TABLE 8

% WEED CONTROL AT 28 DAYS WITH S-METOLACHLOR

| TREATMENT | % WEED CONTROL FOR PALMER AMARANTH | % WEED CONTROL FOR FALL PANICUM | % WEED CONTROL FOR LARGE CRABGRASS |
|---|---|---|---|
| Untreated Control | 0 | 0 | 0 |
| 1.5 parts/acre in Deionized Water | 100.0 | 100.0 | 100.0 |
| 1.5 parts/acre in SymMAX™ | 100.0 | 100.0 | 100.0 |
| 1 part/acre in Deionized Water | 100.0 | 97.3 | 99.7 |
| 1 part/acre in SymMAX™ | 100.0 | 96.0 | 99.5 |
| 0.75 part/acre in Deionized Water | 98.8 | 88.3 | 90.0 |
| 0.75 part/acre in SymMAX™ | 100.0 | 98.7 | 99.9 |

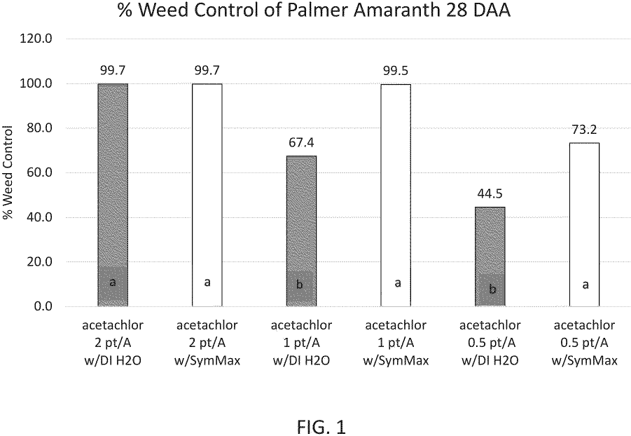

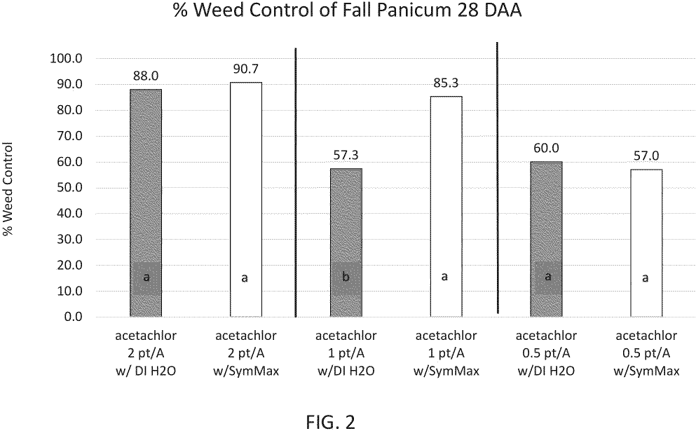

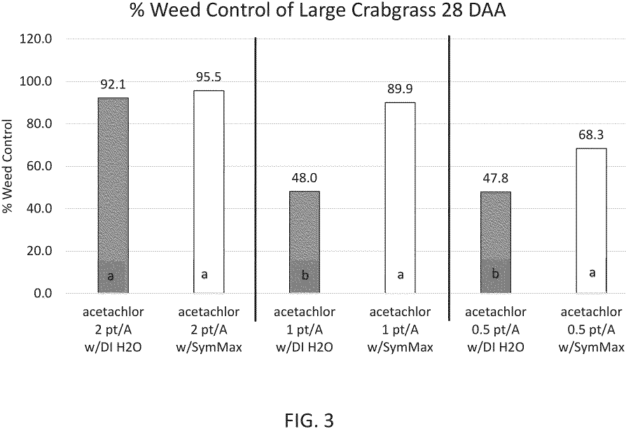

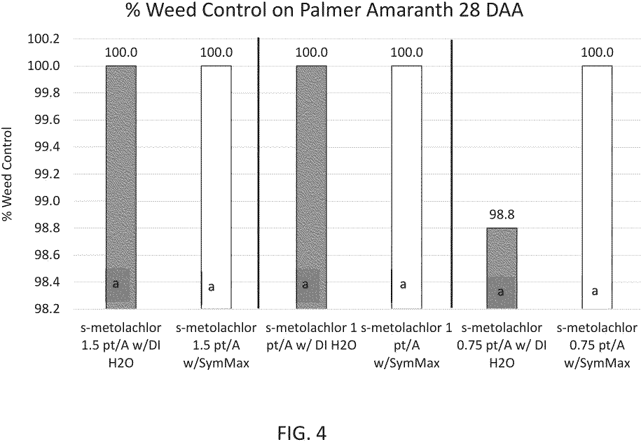

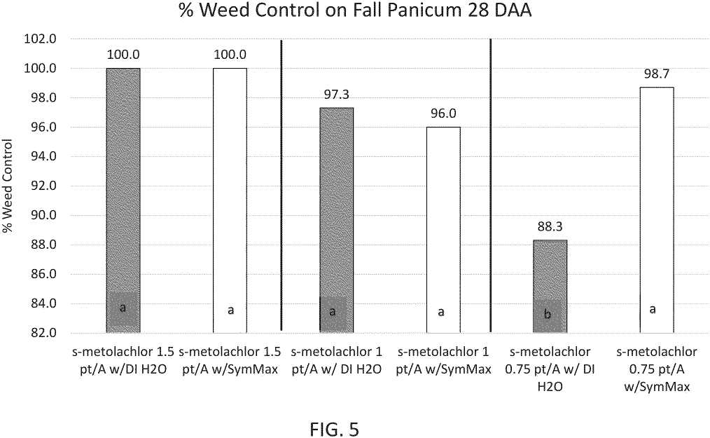

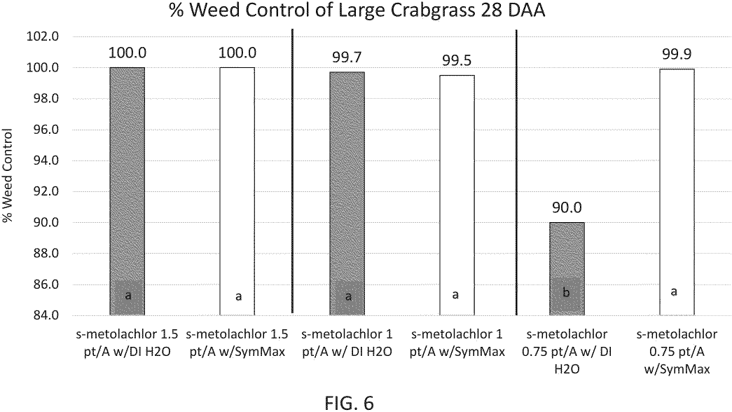

FIGS. 1-6 provide the results of the testing on palmer amaranth, fall panicum and large crabgrass after 28 days. The data represented in the figures is the means of the 4-replicates as recorded by the researcher and analyzed using ANOVA statistical analysis. The letters in the figures denote the statistical difference at P=0.05. As can be seen from FIGS. 1-6, treatments that combined an herbicide with SymMAX™ supramolecular host chemistry had generally greater weed control in palmer amaranth, fall panicum, and large crabgrass compared to treatments without SymMAX™ supramolecular host water mixture. None of the treatments resulted in any phytotoxicity to the crop when compared to the untreated control for each trial.

It was determined that by forming supramolecular structures with herbicides, a positive physiological effect in the weeds treated with herbicide was obtained, and there was no crop phototoxicity. Treatments including SymMAX™ supramolecular chemistry provide similar weed control to the full label rate of the herbicide, but at half the rate of the herbicide, i.e., half the amount per acre.

### Example 2: Effect of Compositions on Palmer Amaranth, Ivyleaf Morning Glory, Fall Panicum, and Large Crabgrass

The herbicides tested were glufosinate, glyphosate, and mesotrione. Each herbicide was combined at the specified rate with either deionized water or SymMAX™ supramolecular host water mixture commercially available from Shotwell Hydrogenics at 15 gallons per acre (GPA). Specified rates for glufosinate were 22 ounces per acre, 11 ounces per acre, and 5.5 ounces per acre. Specified rates for glyphosate were 22 ounces per acre, 11 ounces per acre, and 5.5 ounces per acre. Specified rates for mesotrione were 3 ounces per acre, 2 ounces per acre, and 1 ounce per acre.

This example was conducted as a 4 replicate, RCBD (randomized control block design) in Quitman, GA. An untreated control was used as a standard that provided no weed control and no phytotoxicity. All treatments were compared to the untreated control. Counted dead weeds and living weeds were used to determine % weed control. The untreated control was also used to determine % crop phytotoxicity for the crop. Typical indications of phytotoxicity include chlorosis, stunting, epinasty, and/or leaf burn.

The trial ran for 14 days with weekly data assessments taken on % crop phytotoxicity and % weed control of four key species: palmer amaranth (Amaranthus palmeri), ivyleaf morning glory (Ipomoea hederacea), fall panicum (Panicum dichotomiflorum) and large crabgrass (Digitaria sanguinalis The test field was over seeded with weed seed obtained from the University of Georgia prior to corn planting. Treatments were applied as a broadcast treatment when corn had reached physiological growth stage V3 and weeds were in the 2-4″ size range. Treatments were applied at various rates ranging from about 1 ounce per acre to about 22 ounces per acre. Tables 9-10 show the % weed control when the weeds are treated with glufosinate. Tables 11-12 show the % weed control when the weeds are treated with glyphosphate. Tables 13-14 show the % weed control when the weeds are treated with mesotrione.

TABLE 9

% WEED CONTROL AT 7 DAYS WITH GLUFOSINATE

| TREATMENT | % WEED CONTROL FOR PALMER AMARANTH | % WEED CONTROL FOR IVYLEAF MORNINGLORY | % WEED CONTROL FOR FALL PANICUM | % WEED CONTROL FOR LARGE CRABGRASS |
|---|---|---|---|---|
| Untreated Control | 0.0 | 0.0 | 0.0 | 0.0 |
| 22 ounces/acre in Deionized Water | 82.6 | 70.1 | 100.0 | 100.0 |
| 22 ounces/acre in SymMAX™ | 90.3 | 73.9 | 100.0 | 100.0 |
| 11 ounces/acre in Deionized Water | 77.9 | 52.3 | 99.5 | 100.0 |
| 11 ounces/acre in SymMAX™ | 77.8 | 47.2 | 100.0 | 100.0 |
| 5.5 ounces/acre in Deionized Water | 51.5 | 16.5 | 100.0 | 100.0 |
| 5.5 ounces/acre in SymMAX™ | 56.0 | 16.9 | 97.5 | 99.5 |

TABLE 10

% WEED CONTROL AT 14 DAYS WITH GLUFOSINATE

| TREATMENT | % WEED CONTROL FOR PALMER AMARANTH | % WEED CONTROL FOR IVYLEAF MORNINGLORY | % WEED CONTROL FOR FALL PANICUM | % WEED CONTROL FOR LARGE CRABGRASS |
|---|---|---|---|---|
| Untreated Control | 0.0 | 0.0 | 0.0 | 0.0 |
| 22 ounces/acre in Deionized Water | 76.1 | 64.0 | 95.5 | 100.0 |
| 22 ounces/acre in SymMAX™ | 84.1 | 62.8 | 98.9 | 100.0 |
| 11 ounces/acre in Deionized Water | 69.3 | 41.2 | 92.7 | 99.5 |
| 11 ounces/acre in SymMAX™ | 72.1 | 44.2 | 97.4 | 99.3 |
| 5.5 ounces/acre in Deionized Water | 29.0 | 5.1 | 83.3 | 91.8 |
| 5.5 ounces/acre in SymMAX™ | 34.5 | 5.1 | 88.7 | 97.0 |

TABLE 11

% WEED CONTROL AT 7 DAYS WITH GLYPHOSATE

| TREATMENT | % WEED CONTROL FOR PALMER AMARANTH | % WEED CONTROL FOR IVYLEAF MORNINGLORY | % WEED CONTROL FOR FALL PANICUM | % WEED CONTROL FOR LARGE CRABGRASS |
|---|---|---|---|---|
| Untreated Control | 0.0 | 0.0 | 0.0 | 0.0 |
| 22 ounces/acre in Deionized Water | 81.9 | 28.0 | 98.8 | 100.0 |
| 22 ounces/acre in SymMAX™ | 86.8 | 33.1 | 100.0 | 99.8 |
| 11 ounces/acre in Deionized Water | 76.4 | 13.5 | 97.5 | 97.8 |
| 11 ounces/acre in SymMAX™ | 80.8 | 32.9 | 95.3 | 99.3 |
| 5.5 ounces/acre in Deionized Water | 63.8 | 14.3 | 85.8 | 90.8 |
| 5.5 ounces/acre in SymMAX™ | 51.3 | 10.1 | 90.8 | 92.8 |

TABLE 12

% WEED CONTROL AT 14 DAYS WITH GLYPHOSATE

| TREATMENT | % WEED CONTROL FOR PALMER AMARANTH | % WEED CONTROL FOR IVYLEAF MORNINGLORY | % WEED CONTROL FOR FALL PANICUM | % WEED CONTROL FOR LARGE CRABGRASS |
|---|---|---|---|---|
| Untreated Control | 0.0 | 0.0 | 0.0 | 0.0 |
| 22 ounces/acre in Deionized Water | 83.5 | 76.3 | 98.4 | 98.0 |
| 22 ounces/acre in SymMAX™ | 93.1 | 80.0 | 99.6 | 100.0 |
| 11 ounces/acre in Deionized Water | 75.8 | 59.8 | 95.4 | 94.0 |
| 11 ounces/acre in SymMAX™ | 89.1 | 61.0 | 98.0 | 98.0 |
| 5.5 ounces/acre in Deionized Water | 58.3 | 9.7 | 81.8 | 89.0 |
| 5.5 ounces/acre in SymMAX™ | 54.3 | 16.9 | 83.4 | 91.8 |

TABLE 13

% WEED CONTROL AT 7 DAYS WITH MESOTRIONE

| TREATMENT | % WEED CONTROL FOR PALMER AMARANTH | % WEED CONTROL FOR IVYLEAF MORNINGLORY | % WEED CONTROL FOR FALL PANICUM | % WEED CONTROL FOR LARGE CRABGRASS |
|---|---|---|---|---|
| Untreated Control | 0.0 | 0.0 | 0.0 | 0.0 |
| 3 ounces/acre in Deionized Water | 99.0 | 94.2 | 87.3 | 91.5 |
| 3 ounces/acre in SymMAX™ | 99.9 | 96.1 | 91.3 | 88.3 |
| 2 ounces/acre in Deionized Water | 97.7 | 91.6 | 72.3 | 81.5 |
| 2 ounces/acre in SymMAX™ | 98.0 | 91.9 | 82.3 | 87.5 |
| 1 ounce/acre in Deionized Water | 87.4 | 64.5 | 62.8 | 62.3 |
| 1 ounce/acre in SymMAX™ | 90.9 | 67.9 | 70.8 | 73.5 |

TABLE 14

% WEED CONTROL AT 14 DAYS WITH MESOTRIONE

| TREATMENT | % WEED CONTROL FOR PALMER AMARANTH | % WEED CONTROL FOR IVYLEAF MORNINGLORY | % WEED CONTROL FOR FALL PANICUM | % WEED CONTROL FOR LARGE CRABGRASS |
|---|---|---|---|---|
| Untreated Control | 0.0 | 0.0 | 0.0 | 0.0 |
| 3 ounces/acre in Deionized Water | 99.3 | 99.1 | 86.0 | 88.5 |
| 3 ounces/acre in SymMAX™ | 99.6 | 99.4 | 86.6 | 90.0 |
| 2 ounces/acre in Deionized Water | 97.0 | 96.5 | 62.3 | 78.8 |
| 2 ounces/acre in SymMAX™ | 99.4 | 96.2 | 73.3 | 76.3 |
| 1 ounce/acre in Deionized Water | 95.1 | 88.8 | 54.8 | 63.0 |
| 1 ounce/acre in SymMAX™ | 97.0 | 90.6 | 62.3 | 71.3 |

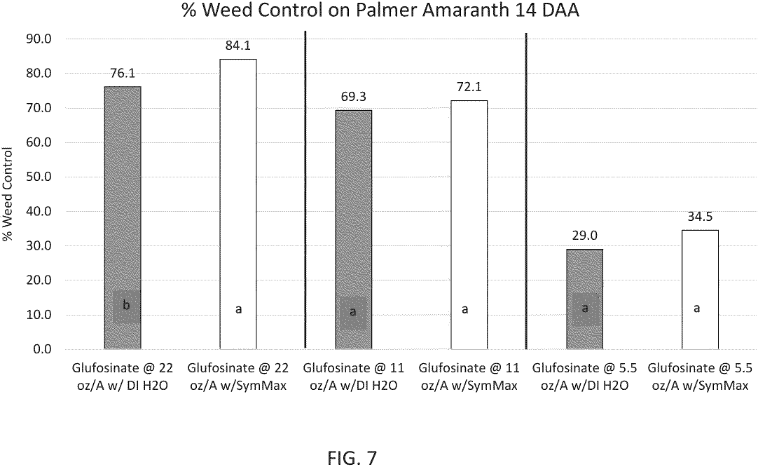

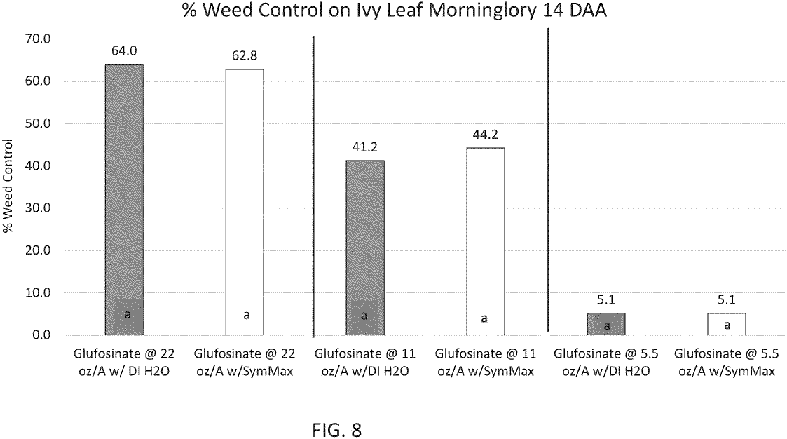

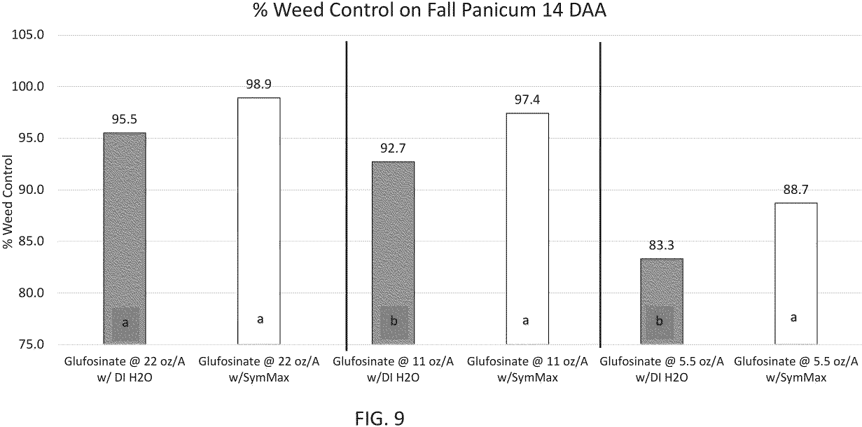

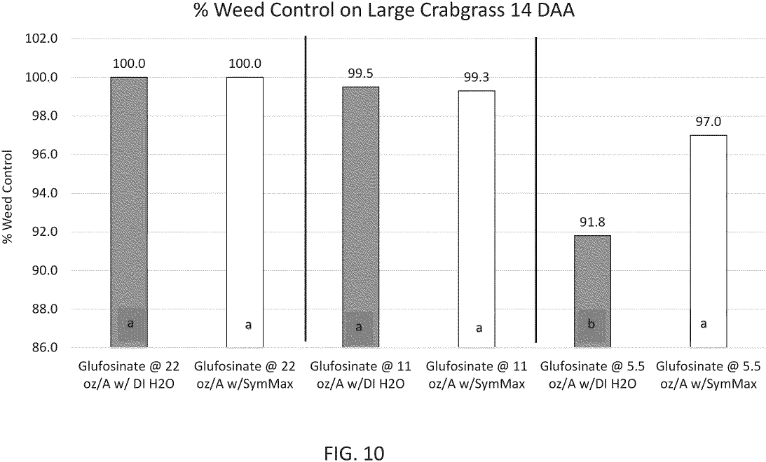

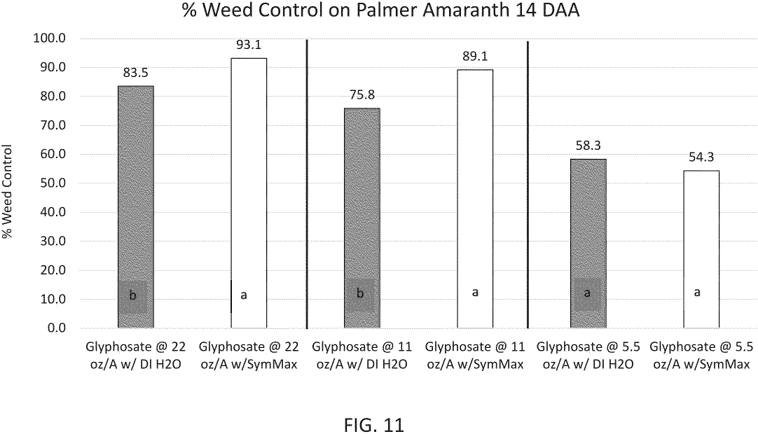

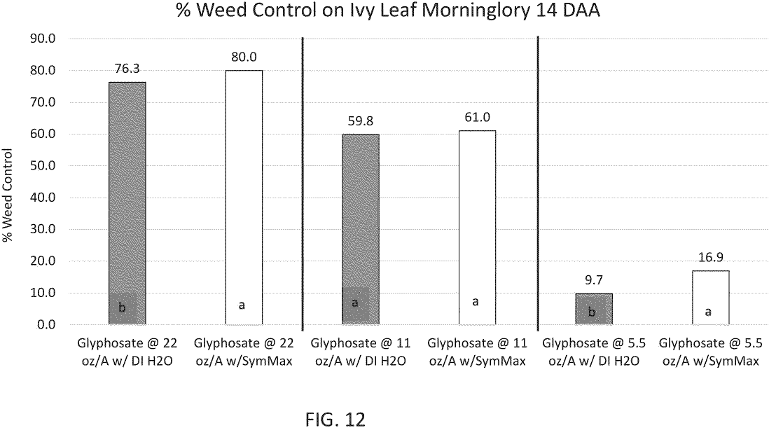

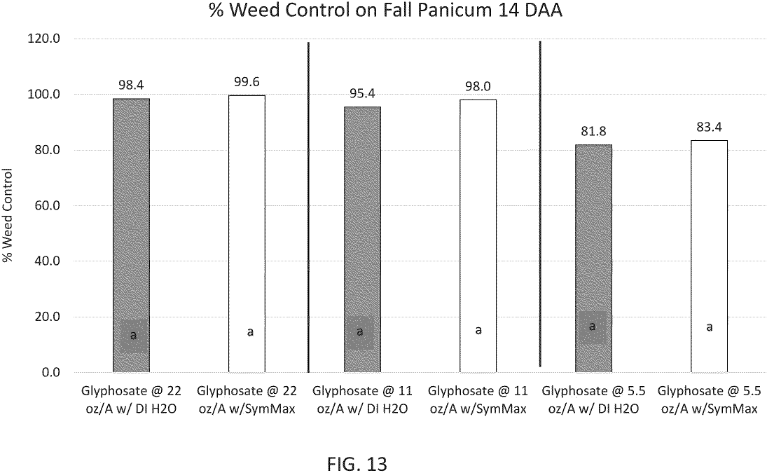

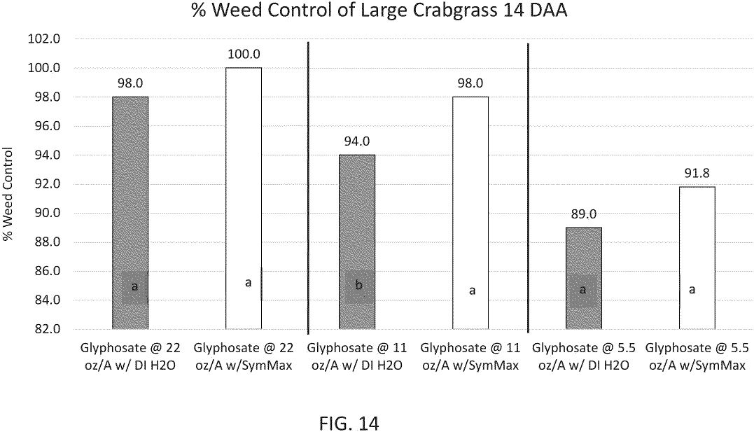

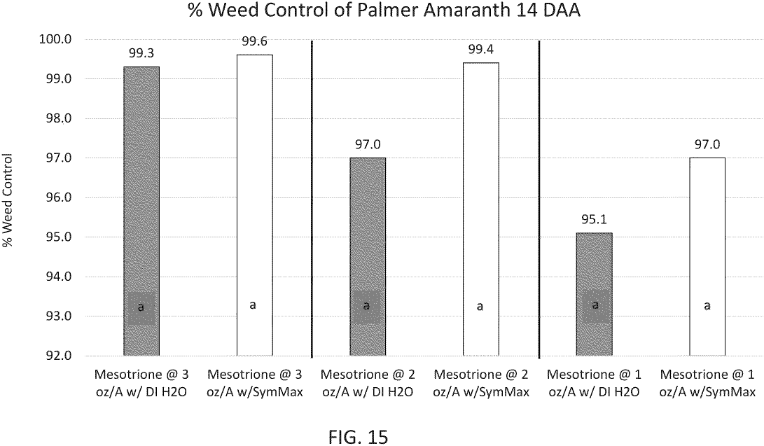

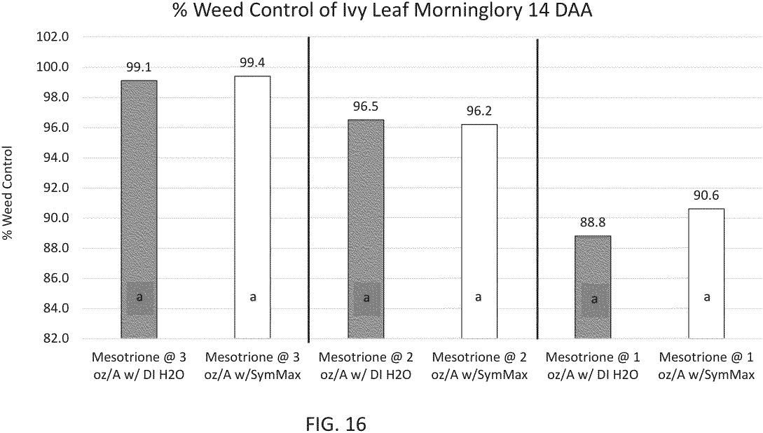

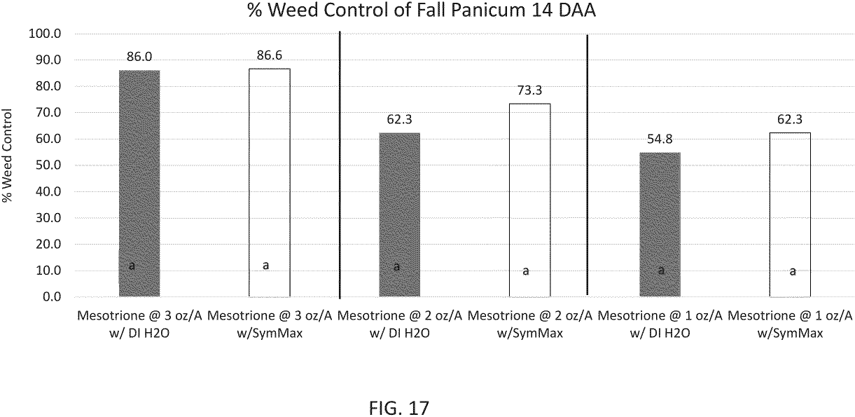

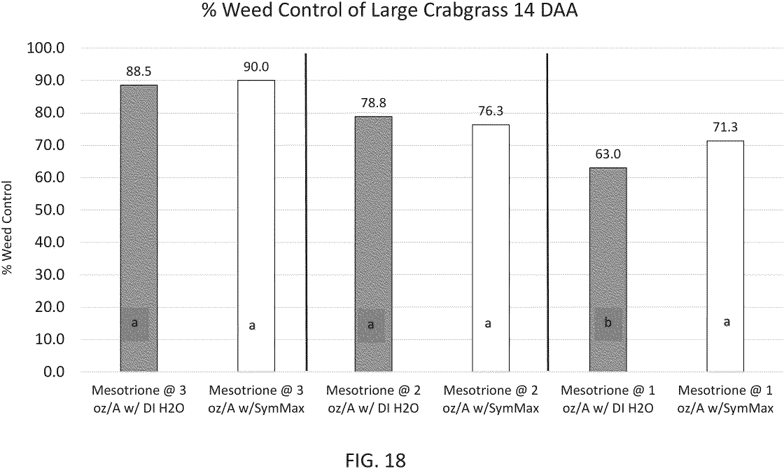

FIGS. 7-18 provide the results of the testing on palmer amaranth, ivyleaf morning glory, fall panicum and large crabgrass after 14 days. The data represented in the figures is the means of the 4-replicates as recorded by the researcher and analyzed using ANOVA statistical analysis. The letters in the figures denote the statistical difference at P=0.05. As can be seen from FIGS. 7-18, treatments that combined a pesticide with SymMAX™ supramolecular host chemsitry had generally greater weed control in palmer amaranth, ivyleaf morning glory, fall panicum, and large crabgrass compared to treatments without SymMAX™ supramolecular host chemistry. None of the treatments resulted in any phytotoxicity to the crop when compared to the untreated control for each trial.

It was determined that by forming supramolecular structures with herbicides, a positive physiological effect in the weeds treated with herbicide was obtained, and there was no crop phototoxicity.

### Example 3: Fungicide In Vitro Studies

A ten replicated in vitro fungal bioassay was conducted to understand the fungicidal compatibilities of fungicidal compositions with supramolecular host chemistries. This research was complete by Dr. Martin Chilvers and Janette Jacobs at Michigan State University in East Lansing, MI.

This example was conducted in 2 phases:

Phase 1: A rate titrate curve was determined on three different fungicides (azoxystrobin, fluxapyroxad, tetraconazole) to determine the effective concentration for 50 percent (EC50) reduction of fungal growth. The pathogens explored are listed in Table 15 below. All three fungicides were procured from Sigma-Aldrich.

Phase 2: Compositions with supramolecular host chemistry at 4 different ratios (0:1, 0.1:1, 0.2:1, and 0.4:1) of supramolecular host chemistry to fungicide active at the EC50 concentrations were blended and tested. SymMAX™ supramolecular host water mixture was procured from Shotwell Hydrogenics.

TABLE 15

PATHOGENS EVALUATED

| | | |
|---|---|---|
| Pathogen | Common Name | Division |
| Botrytis cinerea | Gray mold | Ascomycota |
| Macrophomina phaseoli | Charcoal rot | Ascomycota |
| Pythium irregulare | Damping off/Root rot | Oomycotes |
| Rhizoctonia solani | Collar rot/root rot | Basidiomycota |
| Sclerotinia sclerotiorum | White mold | Ascomycota |
| Fusarium graminearum | Fusarium head blight | Ascomycota |

In vitro studies were completed by growing the six different pathogens in potato dextrose agar (PDA). PDA was procured from Cole-Parmer and the agar was made according to manufacturer’s instructions and autoclaved; when the medium cooled to 51° C., treatments were amended to the medium.

All fungicide stock solutions were prepared by dissolving fungicides in acetone. The treatment volume of fungicide was placed in a 1.5 mL microcentrifuge tube and the treatment volume of SymMAX™ supramolecular host chemistry was added to the fungicide. The combined fungicide-SymMax™ solutions were then amended to the PDA and poured into petri dishes (15 mm x 100 mm).

A single plug from a 5-7 day-old-culture of each fungal organism was placed in the center of each treatment plate (5 replicates/treatment) and incubated in the dark at 24° C. Two individual measurements of the diameter of the cultured organism were taken at 96 hours after transfer to the treatment plates.

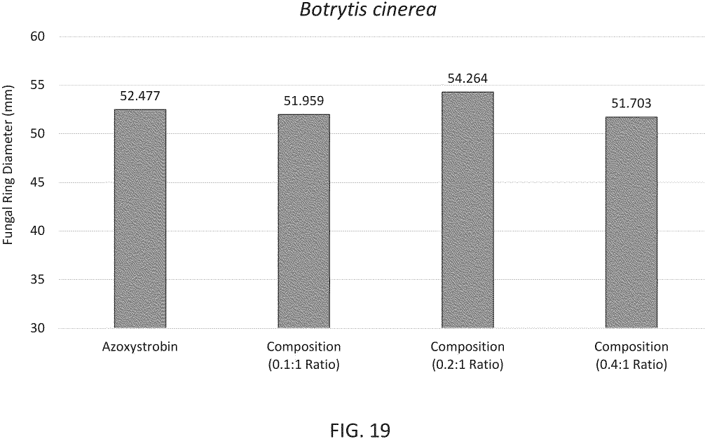

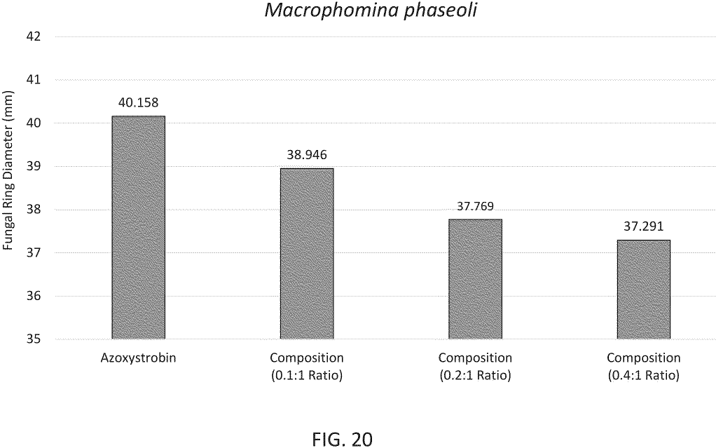

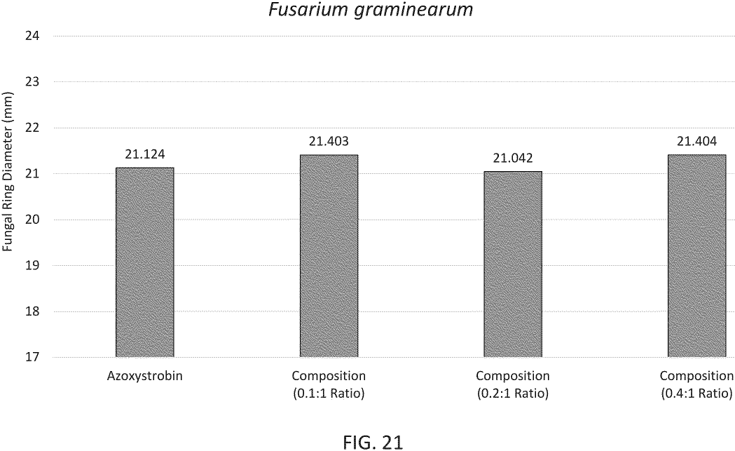

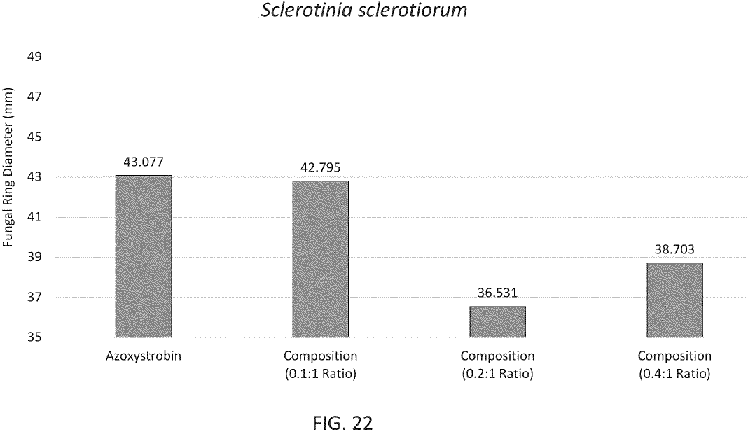

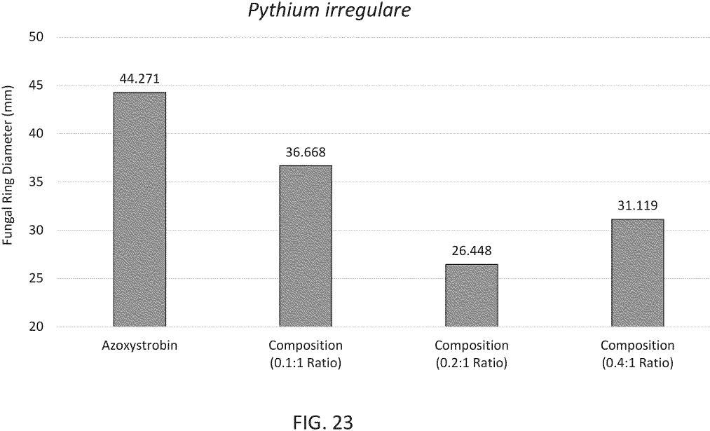

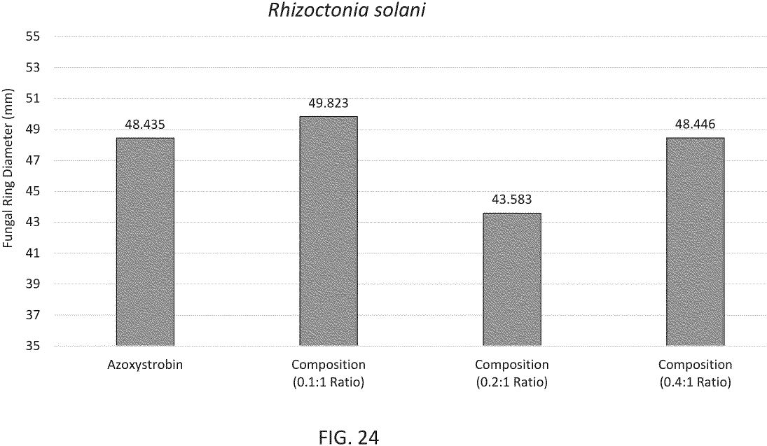

Table 16 provides the results of the fungal reduction for azoxystrobin when mixed with 3 different amounts of supramolecular host chemistry from 0.1 to 0.4:1 ratio to the active. The fungal reduction varied depending on the pathogen from 0.4% to 40%. This may seem nominal of a reduction; however, this comparison was completed at the EC50. FIGS. 19-24 illustrate the results.

TABLE 16

FUNGAL RING DIAMETER (mm) FOR AZOXYSTROBIN

| Pathogen | Azoxystrobin | Composition (0.1:1 Ratio) | Composition (0.2:1 Ratio) | Composition 0.4:1 Ratio) |
|---|---|---|---|---|
| Botrytis cinerea | 52.5 | 52.0 | 54.3 | 51.7 |
| Macrophomina phaseoli | 40.2 | 38.9 | 37.8 | 37.3 |
| Fusarium graminearum | 21.1 | 21.4 | 21.0 | 21.4 |
| Sclerotinia sclerotiorum | 43.1 | 42.8 | 36.5 | 38.7 |
| Pythium irregulare | 44.3 | 36.7 | 26.4 | 31.1 |
| Rhizoctonia solani | 48.4 | 49.8 | 43.6 | 48.4 |

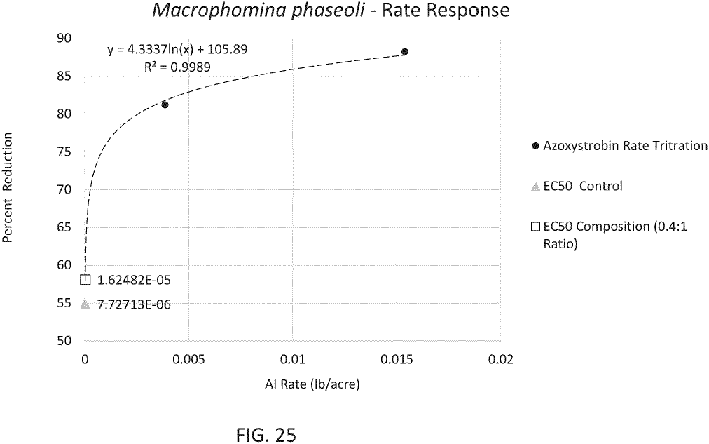

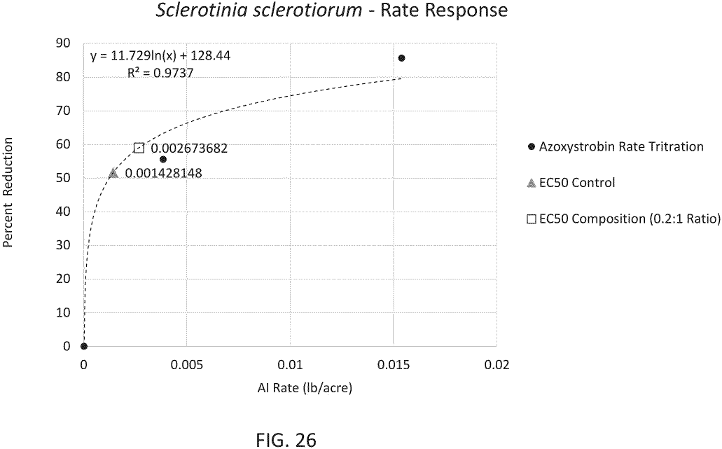

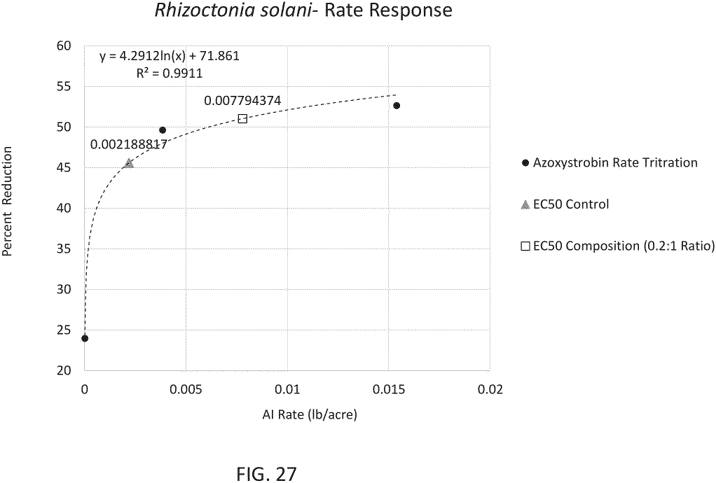

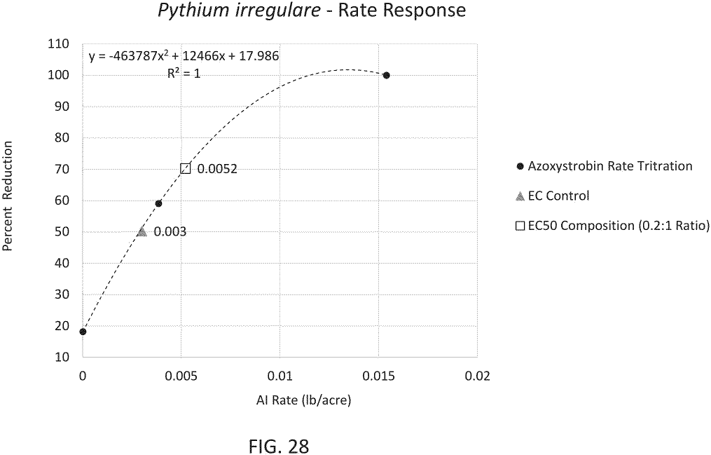

FIGS. 25-28 show the rate titration for azoxystrobin for Macrophomina phaseoli, Rhizoctonia solani, Sclerotinia sclerotiorum, and Pythium irregulare. It was determined that the rate titration had either a logarithmic or polynomial fit, so when comparing the fungal reduction at the EC50 it allows comparison of the equivalent pounds per acre due to the decrease of fungal ring. When the supramolecular host chemistry is mixed with the fungicide an increase from 70% to 250% was observed (i.e. 1 lb/acre of fungicide with supramolecular chemistry host would be equivalent to 1.7 to 3.5 lb/acre without the supramolecular chemistry host).

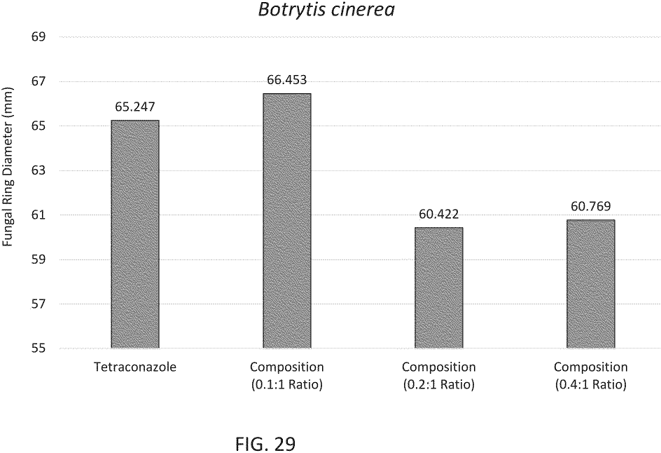

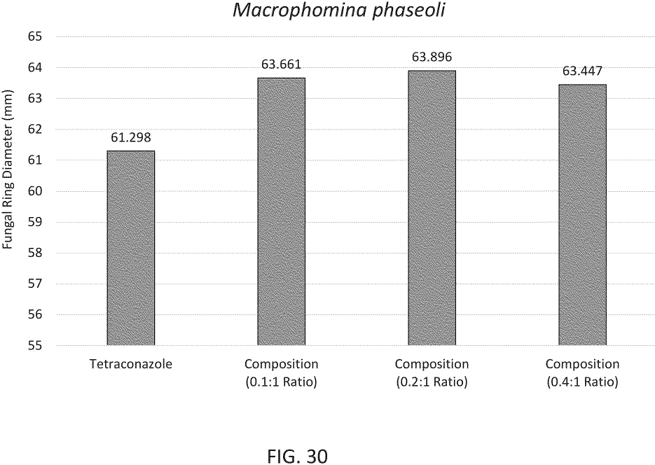

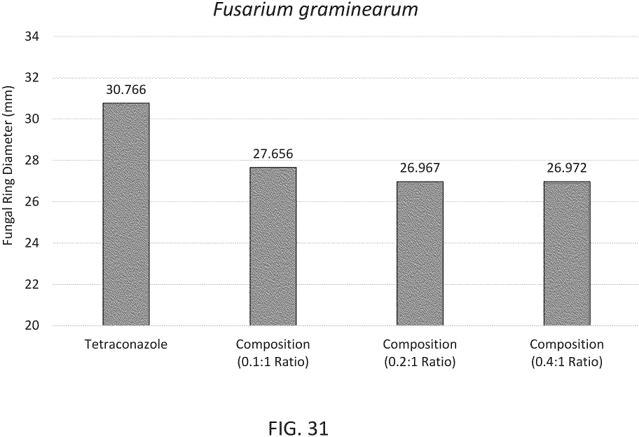

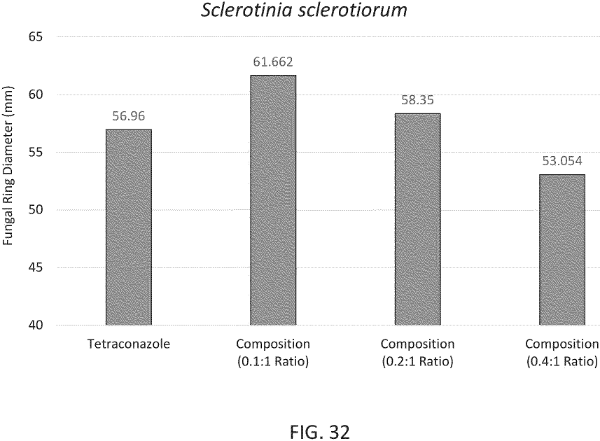

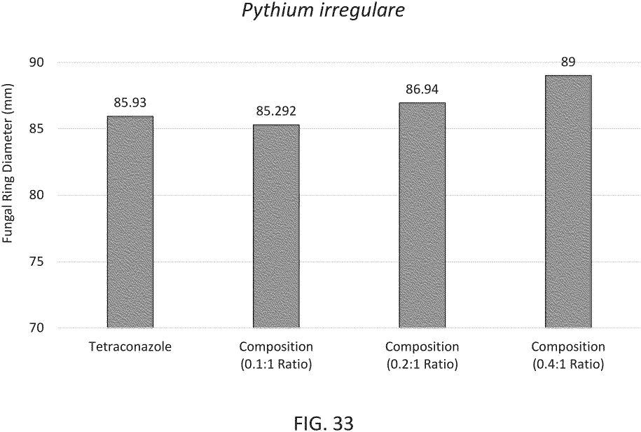

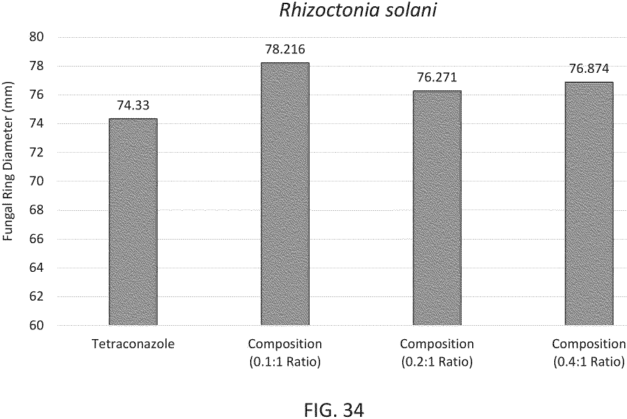

Table 17 provides the results of the fungal reduction for tetraconazole when mixed with 3 different amounts of supramolecular host chemistry from 0.1 to 0.4:1 ratio to the active. The fungal reduction varied depending on the pathogen from -5% to 12%. In some pathogens, a negative performance was observed; this is correlated to not testing the ideal ratio of supramolecular host to active for that pathogen. FIGS. 29-34 illustrate the results.

TABLE 17

FUNGAL RING DIAMETER (mm) FOR TETRACONAZOLE

| Pathogen | Tetraconazole | Composition (0.1:1 Ratio) | Composition (0.2:1 Ratio) | Composition 0.4:1 Ratio) |
|---|---|---|---|---|
| Botrytis cinerea | 65.2 | 66.453 | 60.422 | 60.769 |
| Macrophomina phaseoli | 61.298 | 63.661 | 63.896 | 63.447 |
| Fusarium graminearum | 30.766 | 27.656 | 26.967 | 26.972 |
| Sclerotinia sclerotiorum | 56.96 | 61.662 | 58.35 | 53.054 |
| Pythium irregulare | 85.93 | 85.292 | 86.94 | 89 |
| Rhizoctonia solani | 74.33 | 78.216 | 76.271 | 76.874 |

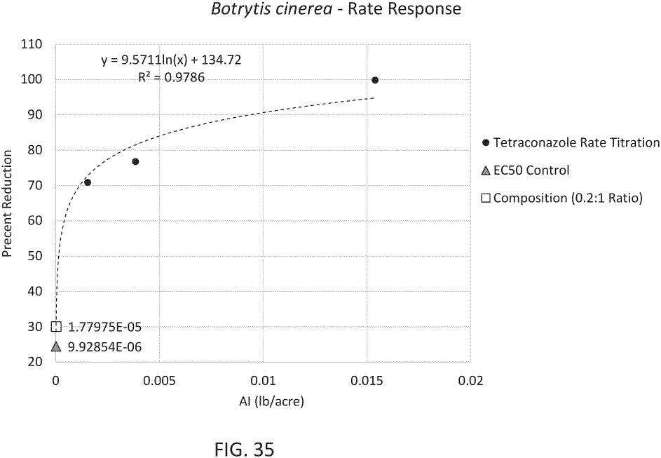

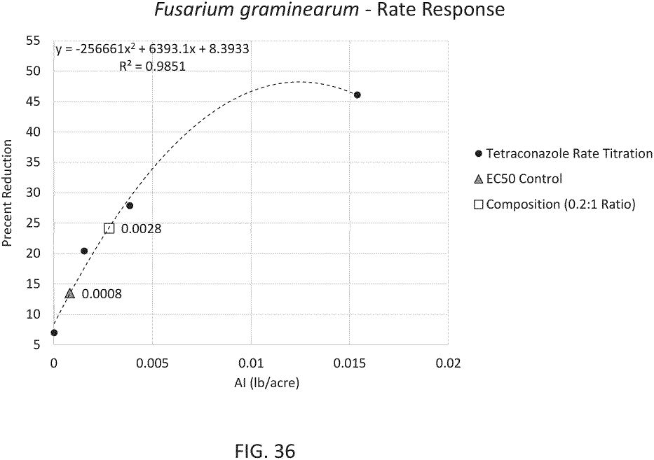

FIGS. 35-36 show the rate titration for tetraconazole for Botrytis cinerea and Fusarium graminearum. It was determined that the rate titration had either a logarithmic or polynomial fit, so when comparing the fungal reduction at the EC50 it allows comparison of the equivalent pounds per acre due to the decrease of fungal ring. When the supramolecular host chemistry is mixed with the fungicide, an increase from 79% to 250% was observed (i.e. 1 lb/acre of fungicide with supramolecular chemistry host would be equivalent to 1.7 to 3.5 lb/acre without the supramolecular chemistry host).

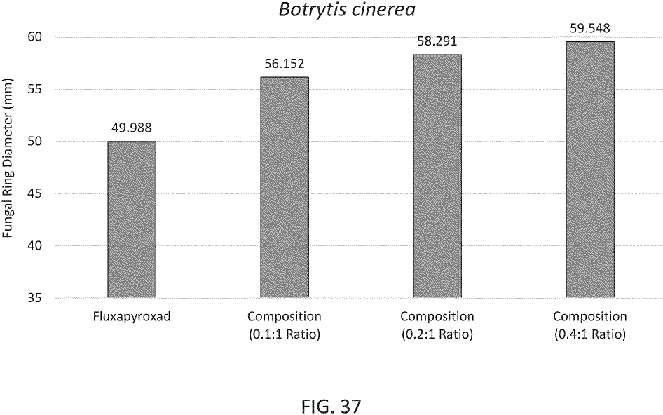

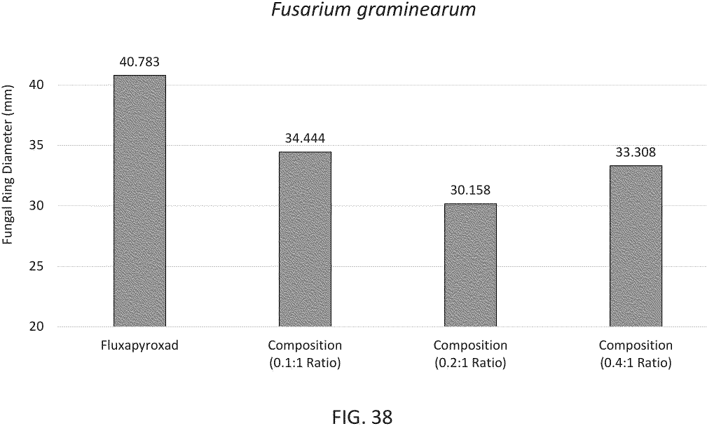

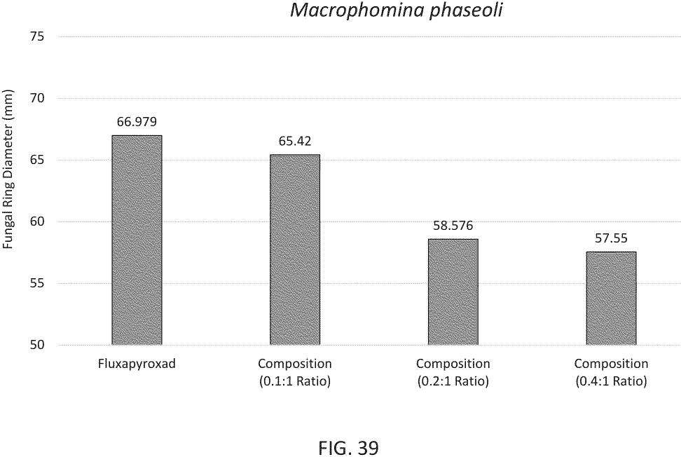

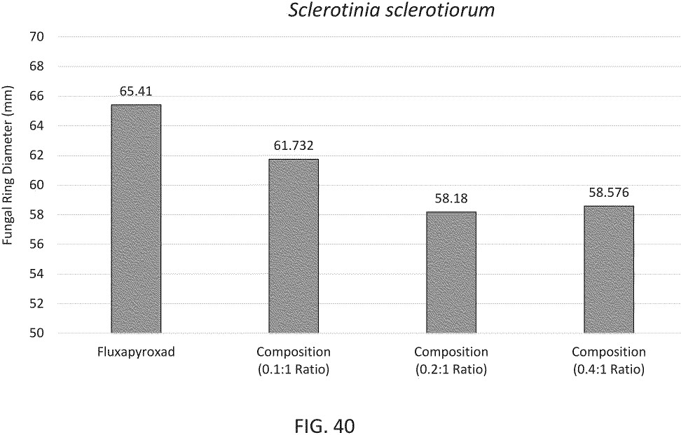

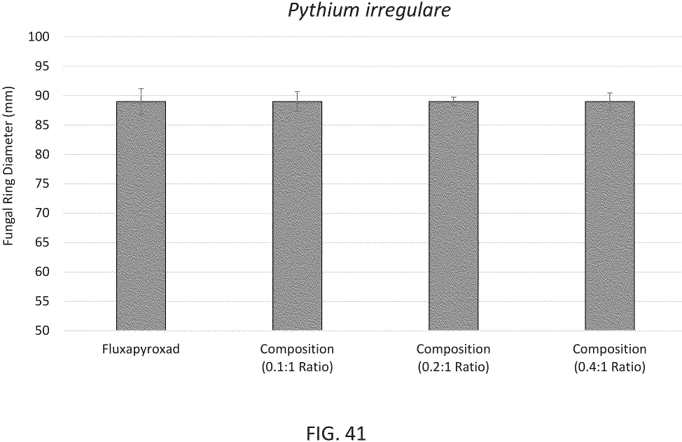

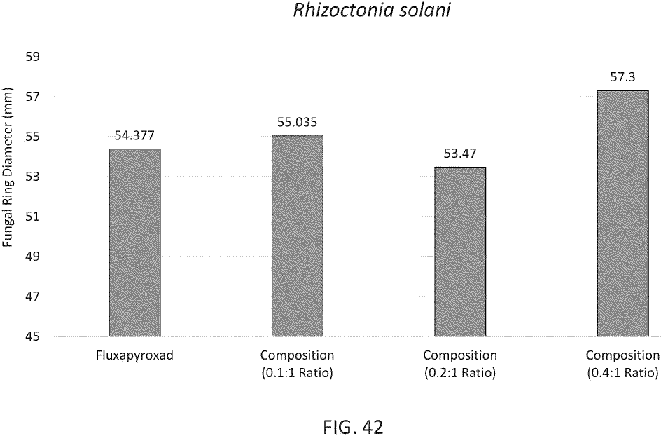

Table 18 provides the results of the fungal reduction for fluxapyroxad when mixed with 3 different amounts of supramolecular host chemistry from 0.1 to 0.4:1 ratio to the active. The fungal reduction varied depending on the pathogen from -12% to 14%. In some pathogens, a negative performance was observed, this is correlated to not testing the ideal ratio of supramolecular host to active for that pathogen. FIGS. 37-42 illustrate the results.

TABLE 18

FUNGAL RING DIAMETER (mm) FOR FLUXAPYROXAD

| Pathogen | Tetraconazole | Composition (0.1:1 Ratio) | Composition (0.2:1 Ratio) | Composition 0.4:1 Ratio) |
|---|---|---|---|---|
| Botrytis cinerea | 49.988 | 56.152 | 58.291 | 59.548 |
| Macrophomina phaseoli | 66.979 | 65.42 | 58.576 | 57.55 |
| Fusarium graminearum | 40.783 | 34.444 | 30.158 | 33.308 |
| Sclerotinia sclerotiorum | 65.41 | 61.732 | 58.18 | 58.576 |
| Pythium irregulare | 89 | 89 | 89 | 89 |
| Rhizoctonia solani | 54.377 | 55.035 | 53.47 | 57.3 |

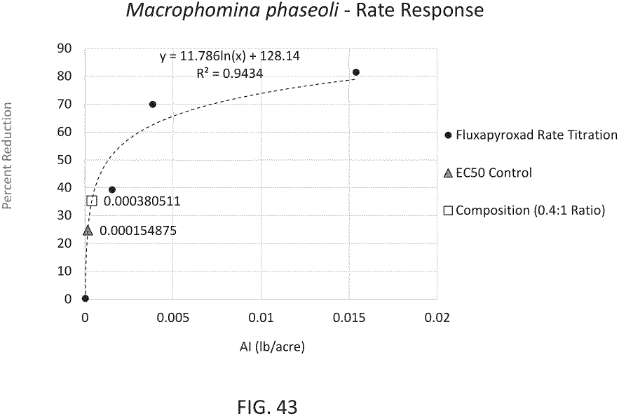

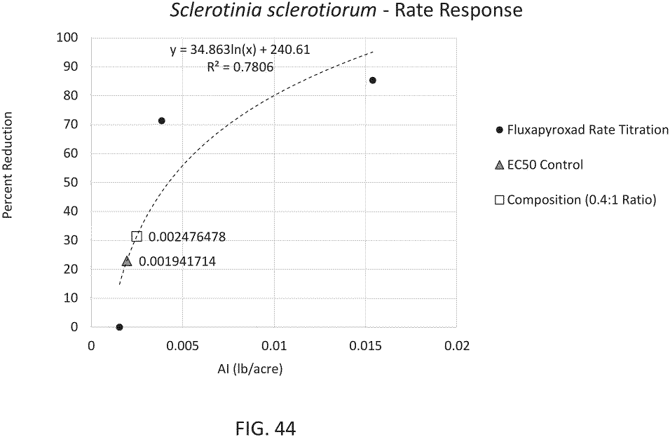

FIGS. 43-44 show the rate titration for fluxapyroxad for Macrophomina phaseoli and Sclerotinia sclerotiorum. It was determined that the rate titration had a logarithmic fit, so when comparing the fungal reduction at the EC50 it allows comparison of the equivalent pounds per acre due to the decrease of fungal ring. When the supramolecular host chemistry is mixed with the fungicide an increase from 28% to 145% was observed (i.e. 1 lb/acre of fungicide with supramolecular chemistry host would be equivalent to 1.3 to 2.5 lb/acre without the supramolecular chemistry host).

### Example 4: Pre-Emergent Herbicide in Plantae Screening Assay

This example was conducted as a 7 replicate, RCBD (randomized complete block design) in plantae herbicide bioassay at Syntech Research in Sanger, CA, by Dr. Parsa Teranchian. The trial was conducted in a climate-controlled greenhouse which maintained temperatures between 67° F. and 83° F. with standard lighting and humidity for the duration of the trial. Seedling weeds received normal irrigation for the duration of the trial.

Three pre-emergent herbicides (Table 19) were tested at various rates based on the commercial label, 1X, 1/2X, and 1/4X of label rate. Supramolecular host compositions were blended by mixing the SymMAX™ supramolecular host chemistry in 50:50 weight by weight with the commercial products. SymMAX™ supramolecular host chemistry was procured from Shotwell Hydrogenics. These supramolecular compositions were sprayed at equivalent label rate and half the active amount was applied to the 50:50 dilution, i.e. 1X label is now 1/2X label rate for all the composition blends (Table 20).

The treatment was sprayed onto two common weeds species (Table 21). Ten (10) seeds of each weed species were planted in 4 x 4″ poly pots filled with commercial potting mix. Data assessments were taken for % Weed Control at 21 days after treatment application.

TABLE 19

PRE-EMERGENT HERBICIDES

| | | |
|---|---|---|
| Common Name | Trade Name | Manufacturer |
| Acetochlor | Warrant® | Monsanto |
| S-metolachlor | Medal® II | Syngenta |
| Trifluralin | Treflan™ | Dow AgroSciences |

* All products were procured at Augusta Cooperative Farm Bureau

TABLE 20

APPLICATION RATES
Untreated Control
SymMax™ @ 8 oz/A
SymMax™ @ 16 oz/A
Warrant® @ 16 oz/A
Warrant® @ 8 oz/A + SymMax™ @ 8 oz/A
Warrant® @ 32 oz/A
Warrant® @ 16 oz/A + SymMax™ @ 16 oz/A
Warrant® @ 64 oz/A
Warrant® @ 32 oz/A + SymMax™ @ 32 oz/A
Medal® II @ 12 oz/A
Medal® II @ 6 oz/A + SymMax™@ 6 oz/A
Medal® II @ 24 oz/A
Medal® II @ 12 oz/A + SymMax™ @ 12 oz/A
Medal® II @ 48 oz/A
Medal® II @ 24 oz/A + SymMax™ @ 24 oz/A
Treflan™ @ 8 oz/A
Treflan™ @ 4 oz/A + SymMax™ @ 4 oz/A
Treflan™ @ 16 oz/A
Treflan™ @ 8 oz/A + SymMax™ @ 8 oz/A
Treflan™ @ 32 oz/A
Treflan™ @ 16 oz/A + SymMax™ @ 16 oz/A

TABLE 21

WEEDS SPECIES SCREENED AGAINST

| | |
|---|---|
| Species | Common name |
| Hemp sesbania | Sesbania herbacea |
| Prickly sida | Sida spinosa |

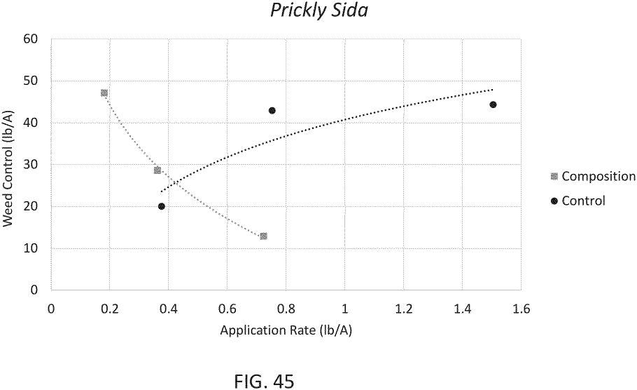

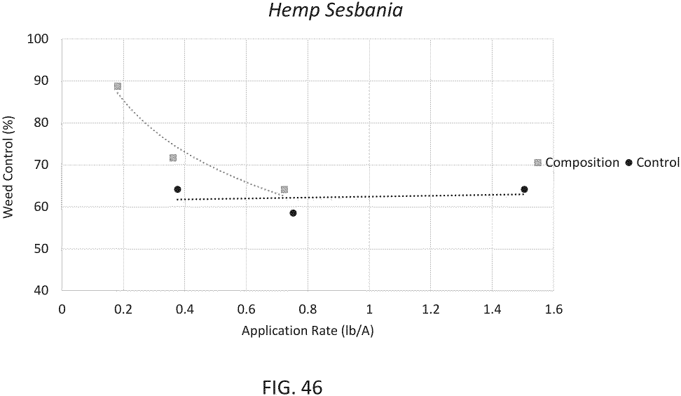

Table 22 provides the rate response for acetochlor with and without supramolecular host chemistry. Completely unexcepted the rate titration for this supramolecular composition showed a reverse rate compared to the control (i.e. less herbicide had more effective weed control). It was determined that this supramolecular composition had better performance at 0.18 lb/acre compared to the control at 1.5 lb/acre, allowing a grower to use 833% less herbicide per acre to achieve the same weed control. FIGS. 45-46 illustrate the results.

TABLE 22

WEED CONTROL WITH ACETOCHLOR

| TREATMENT | LB/ACRE | Hemp sesbania | Prickly sida |
|---|---|---|---|
| Warrant® @ 16 oz/A | 0.376 | 64.13 | 20 |
| Warrant®@ 32 oz/A | 0.752 | 58.49 | 42.9 |
| Warrant® @ 64 oz/A | 1.504 | 64.16 | 44.3 |
| Warrant® @ 8 oz/A + SymMax™ @ 8 oz/A | 0.1808 | 88.69 | 47.1 |
| Warrant® @ 16 oz/A + SymMax™ @ 16 oz/A | 0.3616 | 71.64 | 28.6 |
| Warrant®@ 32 oz/A + SymMax™ @ 32 oz/A | 0.7232 | 64.11 | 12.9 |

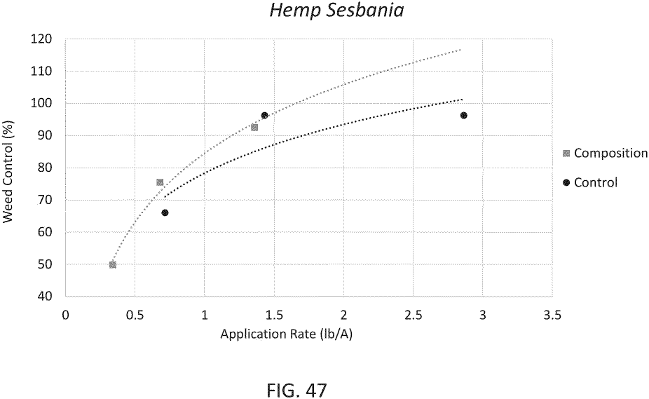

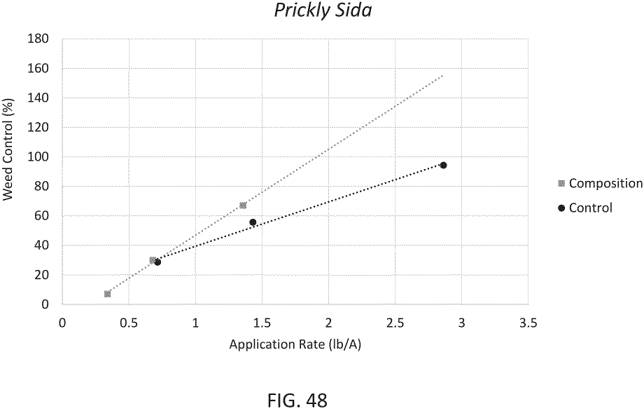

Table 23 shows the rate response for S-metolachlor with and without supramolecular host chemistry. The rate titration for the supramolecular composition showed an increase of weed control compared to the control (i.e. less herbicide had more effective weed control). It was determined that this supramolecular composition had better performance at 1.5 lb/acre compared to the control at 3.0 lb/acre, allowing a grower to use 100% less herbicide per acre to achieve the similar weed control. FIGS. 47-48 illustrate the results.

TABLE 23

WEED CONTROL WITH S-METOLACHLOR

| TREATMENT | LB/ACRE | Hemp sesbania | Prickly sida |
|---|---|---|---|
| Medal® II @ 12 oz/A | 0.715598 | 65.97 | 28.6 |
| Medal® II @ 24 oz/A | 1.431196 | 96.23 | 55.7 |
| Medal® II @ 48 oz/A | 2.862391 | 96.21 | 94.3 |
| Medal® II @ 6 oz/A + SymMax™@ 6 oz/A | 0.33949 | 49.8 | 7.1 |
| Medal® II @ 12 oz/A + SymMax™ @ 12 oz/A | 0.67898 | 75.47 | 30 |
| Medal® II @ 24 oz/A + SymMax™ @ 24 oz/A | 1.35796 | 92.44 | 67.1 |

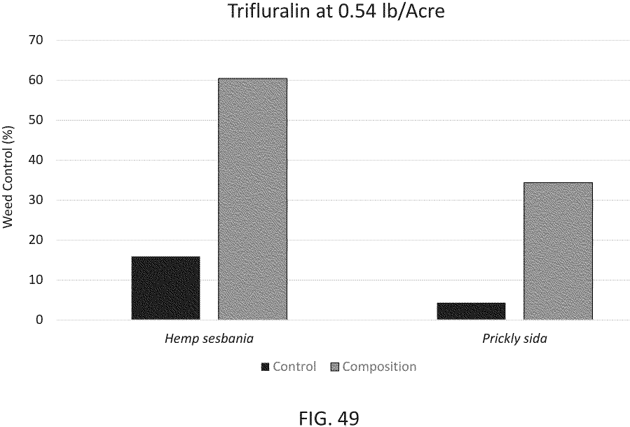

Table 24 shows the weed control for trifluralin with and without supramolecular host chemistry. The supramolecular composition showed an increase of weed control compared to the control (i.e. less herbicide had more effective weed control). It was determined that this supramolecular composition had better performance at 0.54 lb/acre compared to the control showing an increase by 280% for Hemp sesbania and 698% for Prickly sida weed control. FIG. 49 illustrates the results. The control was Treflan™ @ 16 oz/A and the composition was Treflan™ @ 8 oz/A + SymMax™ @ 8 oz/A.

TABLE 24

WEED CONTROL WITH TRIFLURALIN AT 0.54 LB/ACRE

| TREATMENT | Hemp sesbania | Prickly sida |
|---|---|---|
| Control | 15.87 | 4.3 |
| Composition | 60.39 | 34.3 |

### Example 5: Post Emergent Herbicide in Plantae Screening Assay

This example was conducted as a 7 replicate, RCBD (randomized complete block design) in plantae herbicide bioassay at Syntech Research in Sanger, CA, by Dr. Parsa Teranchian. The trial was conducted in a climate-controlled greenhouse which maintained temperatures between 67° F. and 83° F. with standard lighting and humidity for the duration of the trial. Seedling weeds received normal irrigation for the duration of the trial.

Two post-emergent herbicides (Table 25) were tested at various rates based on the commercial label, 1X, 1/2X, and 1/4X of label rate. Supramolecular host compositions were blended by mixing SymMAX™ supramolecular host water mixture in 50:50 weight by weight with the commercial products. SymMAX™ supramolecular host water mixture was procured from Shotwell Hydrogenics. These supramolecular compositions were sprayed at the equivalent label rate and half the active amount was applied to the to 50:50 dilution, i.e. 1X label is now 1/2X label rate for all the composition blends (Table 26).

The treatment was sprayed onto two common weeds species (Table 27). Ten (10) seeds of each weed species were planted in 4 x 4″ poly pots filled with commercial potting mix. Weeds were allowed to grow until they reached approximately 4-6 inches in height, at which time application occurred. Application was made utilizing a moving track spray chamber, with water used as a carrier at 20 gallons per acre (GPA). No additional adjuvants or spray additives were added to treatments. Data assessments were taken for % Weed Control at 21 days after treatment application.

TABLE 25

POST EMERGENT HERBICIDES

| | | |
|---|---|---|
| Common Name | Trade Name | Manufacturer |
| Mesotrione | Calisto® | Syngenta |
| Saflufenacil | Sharpen® | BASF |

* All products were procured at Augusta Cooperative Farm Bureau

TABLE 26

APPLICATION RATES
Untreated Control
SymMax™ @ 8 oz/A
SymMax™ @ 16 oz/A
Calisto®@ 0.75 oz/A
Calisto®@ 0.375 oz + SymMax™ @ 0.375 oz/A
Calisto® @ 1.5 oz/A
Calisto®@ 0.75 oz + SymMax™ @ 0.75 oz/A
Calisto®@ 3 oz/A
Calisto®@ 1.5 oz + SymMax™ @ 1.5 oz/A
Sharpen®@ 0.5 oz/A
Sharpen® @ 0.25 oz + SymMax™ @ 0.25 oz/A
Sharpen® @ 1 oz/A
Sharpen®@ 0.5 oz + SymMax™ @ 0.5 oz/A
Sharpen® @ 2 oz/A
Sharpen®@ 1 oz + SymMax™ @ 1 oz/A

TABLE 27

WEEDS SPECIES SCREENED AGAINST

| | |
|---|---|
| Species | Common name |
| Palmer amaranth | Amaranthus palmeri |
| Redroot pigweed | Amaranthus retroflexus |
| Hemp sesbania | Sesbania herbacea |
| Prickly sida | Sida spinosa |

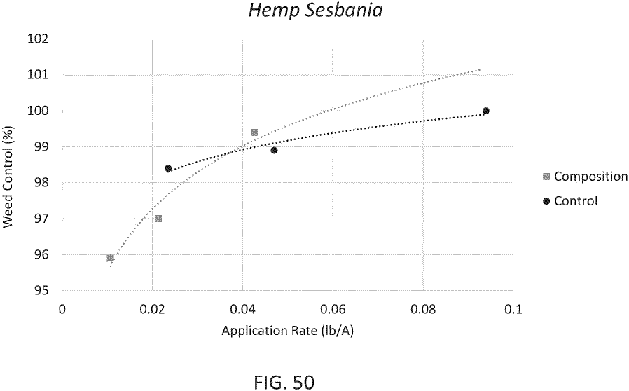

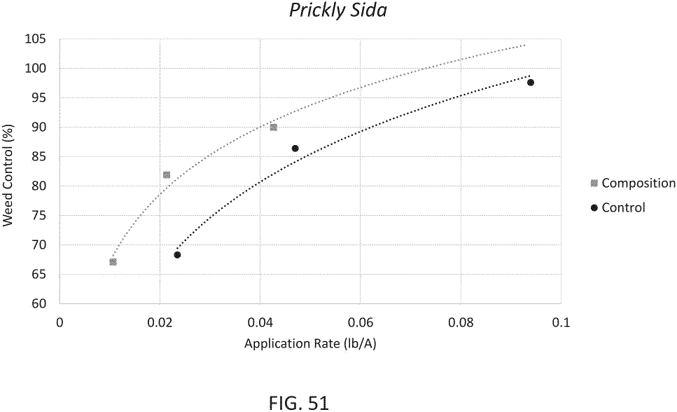

Table 28 provides the rate response for mesotrione with and without supramolecular host chemistry. The rate titration for the supramolecular composition showed an increase of weed control compared to the control (i.e. less herbicide had more effective weed control). It was determined that the supramolecular composition had better performance at 0.6 lb/acre compared to the control at 0.9 lb/acre, allowing a grower to use 33% less herbicide per acre to achieve the similar weed control. FIGS. 50-51 illustrate the results.

TABLE 28

WEED CONTROL WITH MESOTRIONE

| TREATMENT | LB/ACRE | Hemp sesbania | Prickly sida |
|---|---|---|---|
| Calisto®@ 0.75 oz/A | 0.02347146 | 98.4 | 68.3 |
| Calisto® @ 1.5 oz/A | 0.04694292 | 98.9 | 86.4 |
| Calisto®@ 3 oz/A | 0.09388584 | 100 | 97.6 |
| Calisto®@ 0.375 oz + SymMax™ @ 0.375 oz/A | 0.010659955 | 95.9 | 67.1 |
| Calisto®@ 0.75 oz + SymMax™ @ 0.75 oz/A | 0.02131991 | 97 | 81.9 |
| Calisto@ @ 1.5 oz + SymMax™ @ 1.5 oz/A | 0.042639819 | 99.4 | 90 |

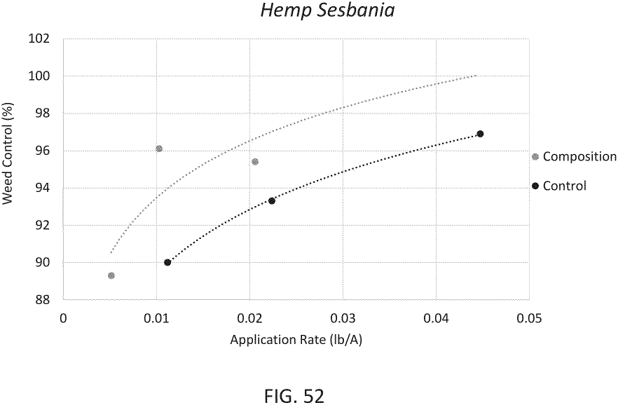

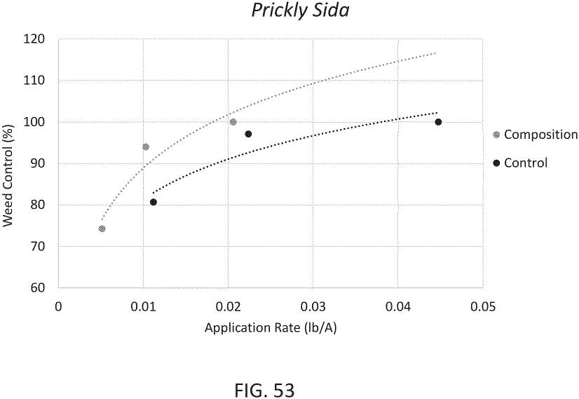

Table 29 provides the rate response for saflufenacil with and without supramolecular host chemistry. The rate titration for the supramolecular composition showed an increase of weed control compared to the control (i.e. less herbicide had more effective weed control). It was determined that the supramolecular composition had better performance at 0.25 lb/acre compared to the control at 0.45 lb/acre, allowing a grower to use 40% less herbicide per acre to achieve the similar weed control. FIGS. 52-53 illustrate the results.

TABLE 29

WEED CONTROL WITH SAFLUFENACIL

| TREATMENT | LB/ACRE | Hemp sesbania | Prickly sida |
|---|---|---|---|
| Sharpen®@ 0.5 oz/A | 0.0112 | 90 | 80.7 |
| Sharpen®@ 1 oz/A | 0.0224 | 93.3 | 97.1 |
| Sharpen®@ 2 oz/A | 0.0447 | 96.9 | 100 |
| Sharpen®@ 0.25 oz + SymMax™ @ 0.25 oz/A | 0.0051 | 89.3 | 74.3 |
| Sharpen®@ 0.5 oz + SymMax™ @ 0.5 oz/A | 0.0103 | 96.1 | 94 |
| Sharpen® @ 1 oz + SymMax™ @ 1 oz/A | 0.0206 | 95.4 | 100 |

### Example 6: Microscopic Images of Supramolecular Structures With Various Pesticide Actives

Multiple currently available pesticide active ingredients (Table 30) were evaluated on microscopic slides for a transformation in chemical structures where a control is compared to a slide with the addition of supramolecular host chemistry.

TABLE 30

PESTICIDE ACTIVE INGREDIENTS SCREENED

| | |
|---|---|
| Active Ingredient | Pesticide Type |
| Pyraclostrobin | Fungicide - Suspension Concentrate |
| Fludioxonil | Fungicide - Suspension Concentrate |
| Pyrimethanil | Fungicide - Suspension Concentrate |
| S-Metolachlor | Herbicide - Emulsified Concentrate |
| Glufosinate Ammonium | Herbicide - Soluble Liquid |
| Glyphosate | Herbicide - Soluble Liquid |
| Malathion | Insecticide - Emulsified Concentrate |
| Chlorantraniliprole | Insecticide - Emulsified Concentrate |

* All products were procured at Sigma-Aldrich

Prior to any below examples, microscopic slides were prepped by cleaning with soap and water, drying, then using an acetone solution and a Kimwipe to assure a clean slide was used with minimal contamination.

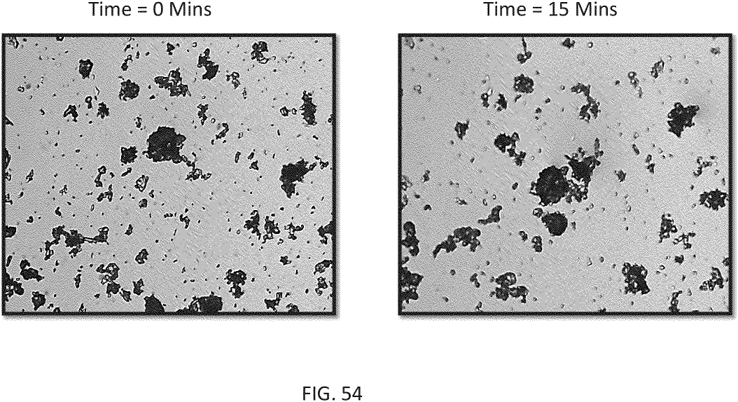

In the example of pyraclostrobin, a fungicide active found in Headline® fungicide and Acceleron® fungicide among others on the market, a wet slide was prepared by adding 100 µL of deionized water to the top of a slide with 2% dispersant from DOW (2 µL, DOW Accent PD-1510). The active pyraclostrobin was then added to the mixture on the slide at 2 mg and mixed together with a pipette tip. The slide was evaluated wet, and immediately placed on an optical microscope after mixing the mixture. SymMAX™ supramolecular host chemistry was then added to the slide at 2 µL. FIG. 54 illustrates images that were captured at time zero and 15-minute, showing the formation of the supramolecular structures in real time with a suspended particle.

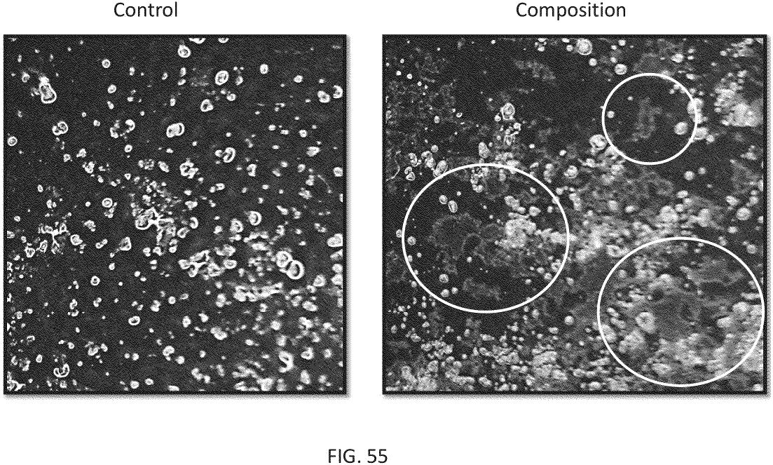

In the example of fludioxonil, a fungicide active found in Maxim® fungicide and Medallion® fungicide among others on the market, a control slide and a treatment slide were prepared using a smear technique. The control slide was prepared using 100 µL of deionized water with 2% dispersant from DOW (2 µL, DOW Accent PD-1510). The active fludioxonil was then added to the mixture on the slide at 1.2 mg and mixed together thoroughly with the pipette tip on the slide. SymMAX™ supramolecular host chemistry was then added at 2 µL and mixed thoroughly on the slide. Both slides were then smeared across the slide and allowed to dry at 75° F. for 4 hours before observation. FIG. 55 shows the dry morphology for the control and the supramolecular composition. Large, interconnected structures were observed.

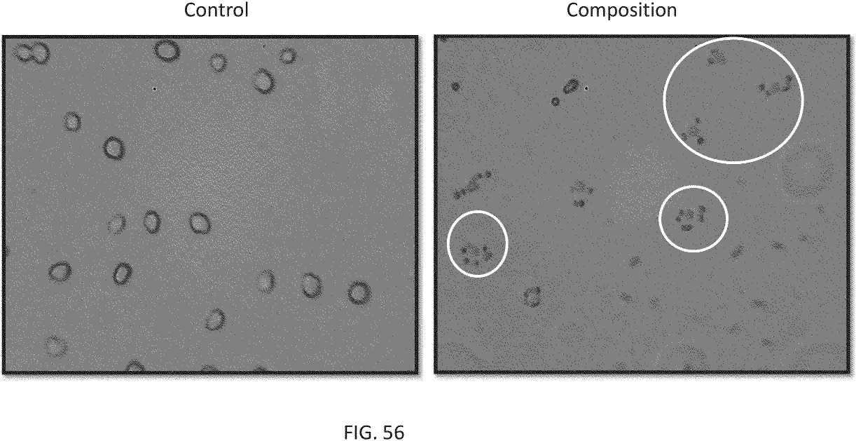

In the example of pyrimethanil, a fungicide active found in Scala® fungicide among others on the market, a control slide and a treatment slide were prepared using a smear technique. The control slide was prepared using 100 µL of deionized water with 2% dispersant from DOW (2 µL, DOW Accent PD-1510). The active pyrimethanil was then added to the mixture on the slide at 1.2 mg and mixed together thoroughly with the pipette tip on the slide. SymMAX™ supramolecular host chemistry was then added at 2 µL and mixed thoroughly on the slide. Both slides were then smeared across the slide and allowed to dry at 20° C. for 4 hours before observation. FIG. 56 shows the dry crystals for the control and composition. Small, clustered crystals were observed with the supramolecular host chemistry.

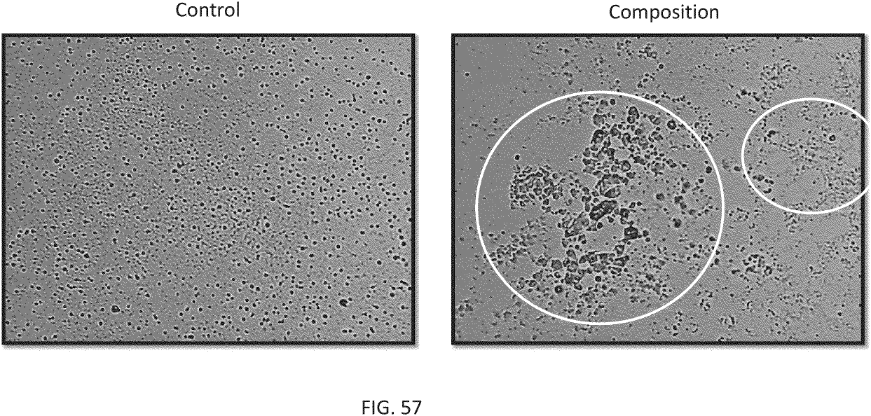

In the example of s-metolachlor, an herbicide active found in Dual II Magnum® herbicide and Medal® herbicide among others on the market, a control slide and a treatment slide were prepared using an acetone method. The control solution was prepared using 1000 µL of acetone. One (1) µL of the active s-metolachlor was then added to the acetone in a 1.5 mL Eppendorf tube and mixed together thoroughly on an orbital shaker for 3-5 minutes. SymMAX™ supramolecular host chemistry was added to the treatment solution in the Eppendorf tube at 2 µL and mixed thoroughly on an orbital shaker for 3-5 minutes. A dilution of each solution was made, 10 µL of each solution was added to 1 mL of acetone and then mixed on an orbital shaker for 3-5 minutes. The dilution was then poured over a slide and allowed to dry for 15 minutes prior to observation under the microscope. FIG. 57 shows the dry crystals for the control and composition. Small, clustered crystals were observed with the supramolecular host chemistry.

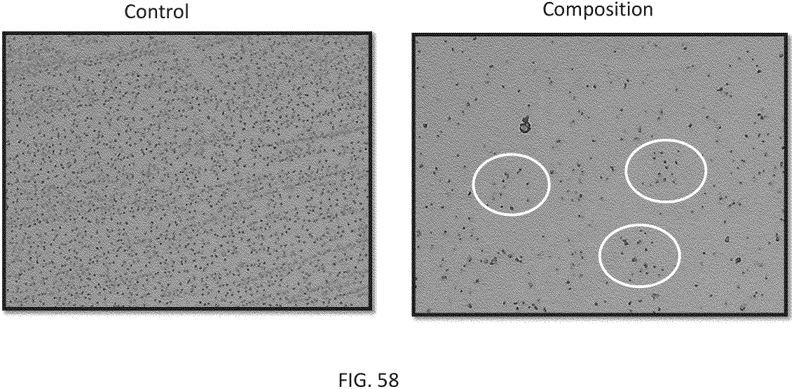

In the example of malathion, an insecticide active found in Fyfanon® insecticide among others on the market, a control slide and a treatment slide were prepared using an acetone method. The control solution was prepared using 1000 µL of acetone. One (1) µL of the active, malathion was then added to the acetone in a 1.5 mL Eppendorf tube and mixed together thoroughly on an orbital shaker for 3-5 minutes. SymMAX™ supramolecular host chemistry was added to the treatment solution in the Eppendorf tube at 2 µL and mixed thoroughly on an orbital shaker for 3-5 minutes. 100 µL of each solution was placed on the slide and allowed to dry for 10-15 minutes prior to observation under the microscope. FIG. 58 shows the dry crystals for the control and composition. Small, clustered crystals were observed with the supramolecular host chemistry.

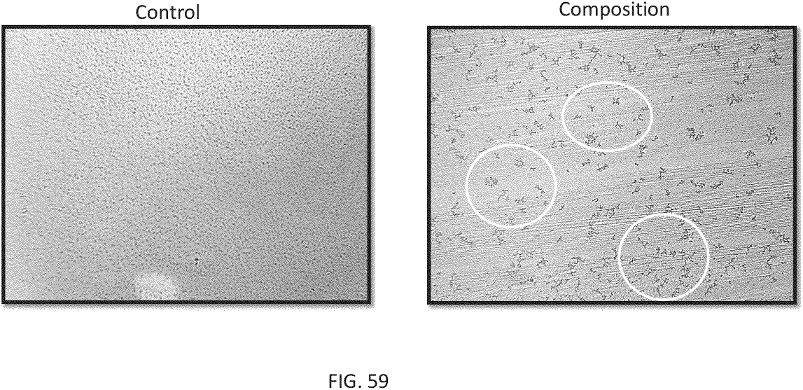

In the example of chlorantraniliprole, an insecticide active found in Rynaxypyr® insecticide among others on the market, a control slide and a treatment slide were prepared using an acetone method. The control solution was prepared using 1000 µL of acetone. One (1) µL of the active chlorantraniliprole was then added to the acetone in a 1.5 mL Eppendorf tube and mixed together thoroughly on an orbital shaker for 3-5 minutes. SymMAX™ supramolecular host chemistry was added to the treatment solution in the Eppendorf tube at 2 µL and mixed thoroughly on an orbital shaker for 3-5 minutes. 100 µL of each solution was placed on the slide and allowed to dry for 10-15 minutes prior to observation under the microscope. FIG. 59 shows the dry crystals for the control and composition. Small, branched clustered crystals were observed with the supramolecular host chemistry.

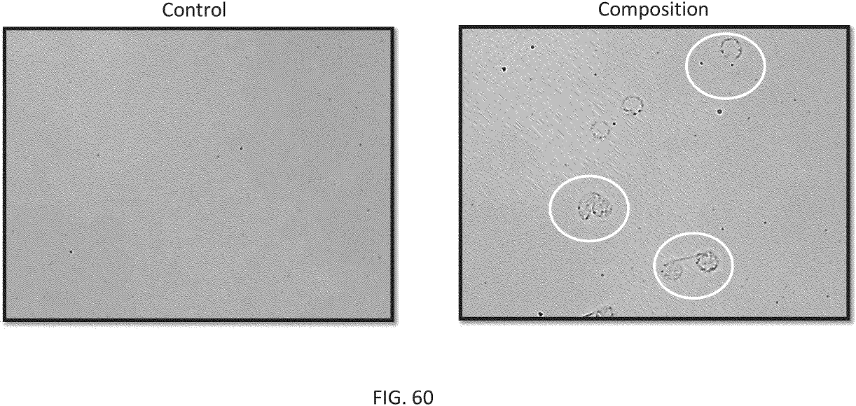

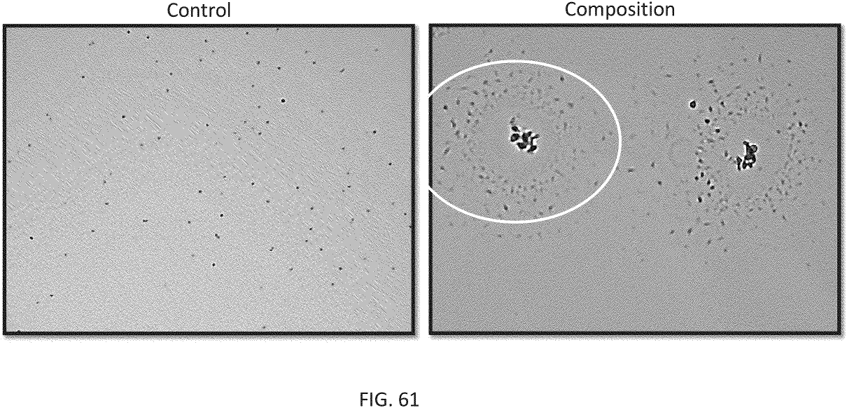

In the example of glyphosate and glufosinate, a 1% w/w solution of glyphosate (and a 1% w/w solution of glufosinate) was made with (50%w/w) and without SymMAX™ supramolecular host chemistry with the rest of the solution being distilled water. Slides were used after cleaning and wrapped with a grade 1 filter paper. Five (5) mL of solution was added by pipette to the top of the slide and allowed to dry over 12 hours. FIGS. 60-61 show similar round supramolecular structures for the supramolecular composition compared to the control which is randomized crystals.

### Example 7:Insecticide In Vitro Studies

In this example, a ten replicated in vitro bioassay was conducted to understand the insecticide compatibilities of insecticide compositions with supramolecular host or guest chemistries. This example utilized a common insecticide, chlorantraniliprole at various application rates to understand the impact of supramolecular chemistry. Chlorantraniliprole is an insecticide active ingredient found in Coragen® insecticide, Ferterra® insecticide, and Acelepryn G® insecticide among others. Chlorantraniliprole, also known as Rynaxypyr, is an insecticide belonging to the chemical group, diamides, with a group 28 mode of action. Chlorantraniliprole opens muscular calcium channels (particularly the ryanodine receptor), rapidly causing paralysis and ultimately death of sensitive species, those being of the order of Lepidoptera and some other Coleoptera, Diptera, and Isoptera species.

A 2x factorial was used for ppm dosages to test with those being 0.005, 0.01, 0.02, 0.04, and 0.08 ppm of chlorantraniliprole. The chlorantraniliprole was sourced from Millipore Sigma, CAS Number: 500008-45-7, with the reference material being the material used for this example. The treatments were 0.005, 0.01, 0.02, 0.04, and 0.08 ppm of chlorantraniliprole as control. The supramolcular compositions were screened at the same rates of chlorantraniliprole with the addition of 23% SymMAX™ supramolecular host chemistry to the active (i.e. 0.08 ppm of active would have 0.0184 ppm 23% SymMAX™ supramolecular host chemistry). SymMAX™ supramolecular host chemistry was sourced from Shotwell Hydrogenics. The insects used for this experiment were Fall armyworms, Spodoptera frugiperda, sourced from Benzon Research of Pennsylvania. Eggs were reared to first instar at 23° C. with a noctuid diet also prepared by Benzon research.

Treatment solutions were prepared by making a stock solution of chlorantraniliprole by dissolving 0.0056 grams of chlorantraniliprole into 49.98 grams of acetone to make a 112 ppm stock solution. The stock solution was diluted to 11 ppm to make the appropriate treatment rates and to make the supramolecular compositions. The 11 ppm stock solution of the control and composition was diluted to 0.005, 0.01, 0.02, 0.04, and 0.08 ppm by diluting to a 100 gram solution of water for the leaf dipping.

Treatments were applied to 1-inch squares of spinach that were dipped in each treatment solution and allowed to dry at room temperature at 20° C. for 2 hours before 5 to 6 fall armyworms were added to a petri dish with filter paper and 1.7 mL of water. Each petri dish represents one repetition of the application and the number of live worms added were recorded on each petri dish and counted at 24 and 48 hours.

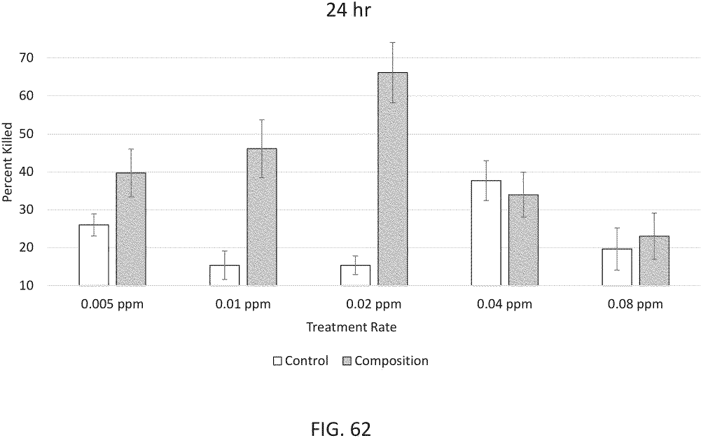

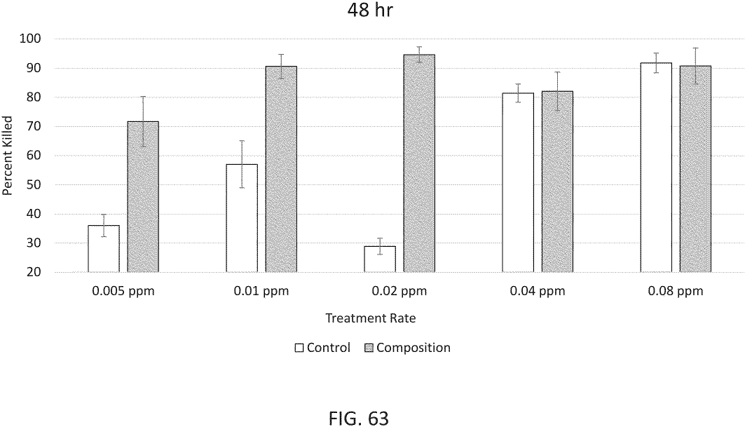

Seen in FIG. 62 at 24 hours after application, the supramolecular composition had superior insect control at the lower rates tested (0.005, 0.01, and 0.02 ppm) and similar effectiveness at higher application rates. Unexpectedly, the lower rates had 53, 200, and 331% increase in insect control at 0.005, 0.01, 0.02 ppm, respectively. A similar trend occurred at the 48 hour interval and the lower application rates (FIG. 63) outperform the control by 99, 59, and 228% at 0.005, 0.01, and 0.02 ppm, respectively. Surprisingly, 0.01 and 0.02 ppm application of the supramolecular composition had greater than 90% insect control and 0.02 ppm outperformed 0.08 ppm of the control (4x reduction of rate). Tables 31 and 32 provide the results.

TABLE 31

PERCENT KILLED AT 24 HOURS

| | 0.005 ppm | 0.01 ppm | 0.02 ppm | 0.04 ppm | 0.08 ppm |
|---|---|---|---|---|---|
| Control | 26.0 | 15.3 | 15.3 | 37.7 | 19.6 |
| Composition | 39.7 | 46.0 | 66.1 | 33.9 | 23.0 |

TABLE 32

PERCENT KILLED AT 48 HOURS

| | 0.005 ppm | 0.01 ppm | 0.02 ppm | 0.04 ppm | 0.08 ppm |
|---|---|---|---|---|---|
| Control | 36.0 | 57.0 | 28.9 | 81.4 | 91.7 |
| Composition | 71.7 | 90.6 | 94.6 | 82.0 | 90.7 |

Although only a few exemplary embodiments have been described in detail above, those of ordinary skill in the art will readily appreciate that many other modifications are possible in the exemplary embodiments without materially departing from the novel teachings and advantages of the present invention. Accordingly, all such modifications are intended to be included within the scope of the present invention as defined in the following claims.

What is claimed is:

1. A composition comprising:
a pesticide;
a supramolecular host or guest chemical configured to engage in host-guest chemistry with the pesticide; and
a solvent.

2. The composition of claim 1, wherein the pesticide comprises an acaricide, an avicide, a chemosterilant, an herbicide, an insecticide, a molluscicide, an algicide, a bactericide, a fungicide, a nematicide, a virucide, a rodenticide, or any combination thereof.

3. The composition of claim 2, wherein the pesticide comprises an herbicide, and the herbicide comprises acetachlor, s-metolachlor, glufosinate, glyphosate, mesotrione, trifluralin, saflufenacil, or any combination thereof.

4. The composition of claim 2, wherein the pesticide comprises a fungicide, and the fungicide comprises azoxystrobin, tetraconazole, fluxapyroxad, pyraclostrobin, fludioxonil, pyrimethanil, or any combination thereof.

5. The composition of claim 2, wherein the pesticide comprises an insecticide, and the insecticide comprises malathion, chlorantraniliprole, or any combination thereof.

6. The composition of claim 1, wherein the pesticide is present in an amount of about 1 percent to about 99 percent by weight of the composition and wherein the supramolecular host chemical or supramolecular guest chemical is present in an amount of about 1 percent to about 99 percent by weight of the composition.

7. (canceled)

8. The composition of claim 1, wherein the supramolecular host chemical is present and comprises a cavitand, a cryptand, a rotaxane, a catenane, a nanostructure, or any combination thereof, or the supramolecular guest chemical is present and comprises cyanuric acid, melamine, or any combination thereof, or both a supramolecular host and guest chemical are present.

9. The composition of claim 1, wherein the supramolecular host chemical is present and comprises a nanostructure having a charge, magnetic properties, or both.

10. The composition of claim 1, wherein the solvent is present in an amount of 0.1 percent to about 75 percent by weight of the composition.

11. A method of preparing the composition of claim 1 , comprising:
mixing components of the composition in the following order:
(1) the solvent, and
(2) the pesticide,
to form a mixture; and
adding (3) the supramolecular host or guest chemical to the mixture to form the composition.

12. A method for controlling unwanted pests at a crop site, comprising:
applying a composition to the crop site in an agriculturally effective amount, the composition comprising:
a pesticide;
a supramolecular host or guest chemical configured to engage in host-guest chemistry with the pesticide; and solvent.

13. The method of claim 12, wherein the composition is applied by soil drench, foliar, fertigation, seed treatment, or aerial methods, or a combination thereof.

14. The method of claim 12, wherein the pests comprise weeds, insects, fungus, or rodents, or any combination thereof.

15. The method of claim 14, wherein the pests comprise weeds, and the weeds are selected to comprise palmer amaranth, ivyleaf morning glory, fall panicum, large crabgrass, redroot pigweed, hemp sesbania, prickly sida, or a combination thereof.

16. The method of claim 12, wherein the crop site is selected to comprise corn.

17. The method of claim 12, wherein the pesticide is selected to comprise an acaricide, an avicide, a chemosterilant, an herbicide, an insecticide, a molluscicide, an algicide, a bactericide, a fungicide, a nematicide, a virucide, a rodenticide, or any combination thereof.

18. The method of claim 17, wherein the pesticide is selected to comprise an herbicide, and the herbicide is selected to comprise acetachlor, s-metolachlor, glufosinate, glyphosate, mesotrione, trifluralin, saflufenacil, or any combination thereof.

19. The method of claim 12, wherein the pesticide is present in an amount of about 1 percent to about 99 percent by weight of the composition and wherein the supramolecular host chemical or supramolecular guest chemical is present in an amount of about 1 percent to about 99 percent by weight of the composition.

20. (canceled)

21. The method of claim 12, wherein the supramolecular host chemical is present and comprises a cavitand, a cryptand, a rotaxane, a catenane, a nanostructure, or any combination thereof, or the supramolecular guest chemical is present and comprises cyanuric acid, melamine, or any combination thereof; or both a supramolecular host and guest chemical are present.

22. The method of claim 12, wherein the supramolecular host chemical is present and comprises a nanostructure having a charge, magnetic properties, or both.

23. The method of claim 12, wherein the composition is applied to the crop site for about 14 days.

24. (canceled)

25. The method of claim 1, wherein the agriculturally effective amount is selected to comprise 0.5 parts of the pesticide per acre of the crop site to about 2 parts of the pesticide per acre of the crop site, or 1 ounce of the pesticide per acre of the crop site to about 22 ounces of the pesticide per acre of the crop site.
